(19) United States
(12) Patent Application Publication
(10) Pub. No.: US 2025/0182144 A1
(43) Pub. Date: Jun. 5, 2025

(54) COMPUTER METHOD AND SYSTEM FOR EVENT ANALYTICS

(71) Applicant: LULULEMON ATHLETICA CANADA INC., Vancouver (CA)

(72) Inventors: Chanceler Orion SHAFFER; Ihejiamatu WOGU, Toronto (CA); John Francis LI, Port Coquitlam (CA); Marcelo Capucci FERREIRA, Langley (CA)

(21) Appl. No.: 18/529,850

(22) Filed: Dec. 5, 2023

(51) Int. Cl. G06Q 30/0201; G06F 9/54; H04L 67/50

(52) U.S. Cl. CPC G06Q 30/0201; G06F 9/542; H04L 67/535

(57) ABSTRACT

Embodiments described herein relate to systems, devices, articles, and methods which in operation process information to define event logic, process, and validate events triggered by user interactions. The system generates digital instructions and output for an online web application, device hosted application, smart device, or similar system. The system receives event input from different sources. For example, system can use sensors or controllers to generate measurements for user gestures which may provide an example source of user event input. As another example, system can receive navigational data or contextual data as event input.

### FIELD

Data analysis including user triggered events and/or digital retail engagement. Automated computer systems and machine learning systems and methods for defining, collecting, analysing, transforming, and validating events, and generating event logic within a complex analytics system.

### INTRODUCTION

Websites, software applications, and other digital tools provide a means of navigation and interaction. Companies regularly analyse user interactions during the use of such websites, software applications, and other digital tools to understand engagement patterns and trends and/or to provide users with improved experiences when navigating a website, software application, or other digital or partially digital environment. Specialized secondary analytics servers can be used to process specific types of interactions. These specialized secondary servers are often siloed, or partially siloed, associated with specific platforms (for example web only), require information about events in specific formats based on proprietary logic, and/or specific data type and data structure requirements.

### SUMMARY

There is a need for improved event analytic systems and methods with improved architectural capacity and methods for transformation, adaptability, validation, and/or defining fluid business logic related to event analytics.

Embodiments described herein involve automated computer systems such as those used in websites, software applications, retail environments, inventory management systems, and other digital tools, interfaces, and machine learning systems for categorizing user activity, categorizing simulated activity, creating grouping logic associated with an activity, receiving a user gesture indicating an activity, evaluating the context of user activity, augmenting user activity with metadata, transforming the augmented user activity data into a universal data shape, providing the universal data structure to a business user interface, transforming the universal data shape into a business user specific data shape, providing the business user specific data shape to a secondary analysis server, providing the results from the secondary analysis server to a business user interface, and using machine learning, artificial intelligence and modelling to improve or modify the logic associated with an activity.

This method and system for event analytics improves currently available event analytics methods and systems by providing greater adaptability, flexibility to update event standard object definitions mid-process, and improved processes for business users.

For the purposes of this disclosure, an activity is defined as an action or non-action, or simulation of an action or non-action, a series of actions, a series of non-actions, or a combination of actions and non-actions, or a simulation of a series of actions. Each action can be associated with a user based on context metadata retrieved from the server or device which registered the activity.

For the purpose of this disclosure, the term event is used to describe an evaluable user activity with a user interface associated with one or more specific identifier and type for which one or more value associated with a type may be assigned.

Events may include standard and custom event types defined within the event analytics system. For example, events may include page load, page view, view content, link click, link hover, form completion, form partial completion, add to cart, add to wishlist, button click, checkout, page scroll, video view, application install, subscribe, login, purchase, search, ad click, button click, add payment info, complete registration, contact, customize product, donate, play audio, audio location, play video, video location, find location, logout, initiate chat conversation, end chat conversation, lead, initiate checkout, schedule, start trial, submit application, change setting, and combinations of the like.

For the purpose of this disclosure the term object is used to describe any set of computer memory stored instructions which store within the object the object's state in fields (and/or variables) and exposes its behavior through methods.

In some embodiments, event analytics are evaluated, assessed, or estimated based on data and data models associated with the user, another user, a model of a user with specific characteristics, an activity, a model of an activity with specific characteristics, a skill level, a membership level, a conversion level and, metadata associated with the user, another user, a model of a user with specific characteristics, an activity, a model of an activity with specific characteristics, a skill level, a membership level, a conversion level, and combinations of the like.

Embodiments provide improved event analytic evaluation and processing of data associated with events and triggers to increase the adaptability, accuracy, and efficiency of event analytics and/or to increase the accuracy of detected relationships within the event data. Embodiments described herein can generate, use, and/or train models for event analytics.

Event analytics system architecture can be challenged by silo-ed event analysis servers, event definitions, and the like that make it difficult without programmer intervention, for a business user to define events or data characteristics related to events which are of interest to the business user. Even in custom built event tracking, in large organizations different teams have silo-ed visions of events and define event data relevant to their team using different definitions or identifiers. This system is designed to receive event data and generate a universal shape, regardless of the source or origination of the input data. The universal shape can then be provided to other third party proprietary or internal silo-ed event analysis systems and tag managers. The business user may input instructions into a business user interface housed within a business user console, which will instruct the event analytics system to create and update the event and transformation logic, contemporaneously. This may be achieved by the business user, using the business user console, identifying data elements within a user event, which will cause the event analytics system to track or retrieve event data and context data associated with a user which can be used for further analysis.

Models can be computer programs or code representations of machine learning or artificial intelligence processes that may be trained with datasets to obtain output results for the event analytics. The event analytics can provide insights of relationships between events and activity data as estimations or predictions.

Embodiments described herein can generate, use, and/or train models for engagement evaluations. Models can be computer programs or code representations of machine learning or artificial intelligence processes that may be trained with datasets to obtain output results for the engagement evaluations. The engagement evaluations can provide insights of relationships between engagement and activity data as estimations or predictions.

In some embodiments user events are associated with gestures such as a swipe, touch, movement or device augmented movement (including through a game controller, touchscreen, mouse, stylus or glove).

Embodiments described herein can involve performing measurements for obtaining the input characterizing a user current baseline behaviour. The input can be sensor data or electrical signals received through an input device stored within a user device, for example.

Within the system, the user device may be one or more of a smart phone, computer, tablet, smart exercise device, fitness tracker, smart mirror, connected fitness system, virtual reality device, virtual reality system, augmented reality device, augmented reality system, and the like. In some embodiments, the system further comprises a messaging system associated with the user event activity to provide an event trigger or define a target shape element through one or more of email, SMS message, MMS message, social media notification or notification message on a user device.

In an aspect, embodiments described herein provide a computer implemented method of operation in a system including an event analytics server associated with one or more listener module on at least one processor. The method involves: receiving, using at least one hardware processor a set of event logic comprising an event model defining more than one user triggered event; wherein the event model comprises a set of elements associated with the more than one user triggered event, wherein the set of elements provide: one or more event model object definition (EMOD) wherein the EMOD defines default values and/or a data element relationship within the system; one or more event standard object definition (ESOD) wherein the ESOD, defines a data model, shape, and event logic comprising an event category hierarchy and type associated with one or more user triggered event; one or more transformation objects definition (TOD) wherein the TOD, defines a model and transformation logic for determining a final shape using the ESOD and one or more EMOD; wherein the ESOD comprises one or more EMOD; wherein the TOD follows the shape of the ESOD and comprises one or more transformation paths, wherein the transformation path specifies a location associated with a value in the event standard object definition (ESOD) associated with a EMOD; receiving, by the event analytics server on at least one processor, a user triggered event input wherein the user triggered event input is defined by the event category hierarchy and type, and one or more values associated with the event, receiving, by the event analytics server, one or more context metadata value; associating the one or more context metadata value with the user triggered event input to define an initial user triggered event input; providing the initial user triggered event input to a listener module; identifying, based on evaluating the event category hierarchy and type, the first associated ESOD and the first associated TOD for the user triggered event input; transforming the values associated with the user triggered event input into a first provisional final shape (1PFS); generating a validation shape (VS) using the associated ESOD to define a required shape structure and required value types; validating the first provisional final shape (1PFS) against the VS; upon validating the first provisional final shape, identifying the first provisional final shape as a first final shape (1FFS) and providing the first final shape.

In some embodiments, the method involves receiving one or more user defined shape element, generating one or more EMOD associated with the one or more user defined shape element, and updating one or more ESOD associated with the one or more user defined shape element.

In some embodiments, the one or more event model object definition (EMOD) defines a nested, hierarchical, or recursive data element relationship within the system.

In some embodiments, providing comprises transmitting and/or outputting the first final shape to a user interface.

In some embodiments, providing comprises transmitting and/or outputting the first final shape to a secondary analytics server.

In some embodiments, the method involves determining that one or more secondary transformations is required for the user triggered event input and generating a second final shape by applying transformation logic to the first final shape.

In some embodiments, providing comprises outputting the second final shape to a secondary analytics server. In some embodiments, the event analytics server generates the secondary transformation.

In some embodiments, the method involves versioning validation wherein a hierarchical version identifier associated with the event analytics server, the ESOD and the one or more EMOD associated with the ESOD share one or more hierarchical elements within the version identifier.

In some embodiments, the method involves transmitting the final shape to a tag manager component.

In some embodiments, the method involves receiving a plurality of user triggered events and providing a plurality of first final shapes, wherein the plurality of user triggered events are triggered simultaneously.

In some embodiments, the method involves receiving another user triggered event input, wherein the other user triggered event input is associated with user engagement and associating one or more context metadata values with the other user triggered event input to define another initial user triggered event input.

In some embodiments, the method involves associating the initial user triggered event input with a secondary analytics server type and secondary set of event logic comprising another event model.

In some embodiments, the method involves transforming the initial user triggered event input to match a set of protocols for the secondary analytics server and sending the transformed initial user triggered event input to the secondary analytics server.

In some embodiments, the method involves using a machine learning module for one or more operations selected from the group of providing additional context metadata for the user triggered event input, monitoring validating of the first provisional final shape, determining common shape types, recommending changes to one or more EMOD, recommending changes to one or more ESOD, determining one or more errors requiring changes to one or more EMOD, determining one or more errors requiring changes to one or more ESOD, generating a new EMOD, and generating a new ESOD.

In an aspect, embodiments described herein provide a processing system that includes one or more processors and one or more memories coupled with the one or more processors, the processing system for event handling and analytics. The system involves: an event analytics server associated with one or more listener module; and one or more non-transitory memory storing a set of event logic comprising an event model defining more than one user triggered event; wherein the event model comprises a set of elements associated with the more than one user triggered event, wherein the set of elements provide: one or more event model object definition (EMOD) wherein the EMOD defines default values and/or a data element relationship within the system; one or more event standard object definition (ESOD) wherein the ESOD, defines a data model, shape, and event logic comprising an event category hierarchy and type associated with one or more user triggered event; one or more transformation objects definition (TOD) wherein the TOD, defines a model and transformation logic for determining a final shape using the ESOD and one or more EMOD; wherein the ESOD comprises one or more EMOD; wherein the TOD follows the shape of the ESOD and comprises one or more transformation paths, wherein the transformation path specifies a location associated with a value in the event standard object definition (ESOD) associated with a EMOD; wherein the event analytics server comprises at least one processor to: receive a user triggered event input wherein the user triggered event input is defined by the event category hierarchy and type, and one or more values associated with the event; receive one or more context metadata value; associate the one or more context metadata value with the user triggered event input to define an initial user triggered event input; provide the initial user triggered event input to a listener module; identify, based on evaluating the event category hierarchy and type, the first associated ESOD and the first associated TOD for the user triggered event input; transform the values associated with the user triggered event input into a first provisional final shape (1PFS); generate a validation shape (VS) using the associated ESOD to define a required shape structure and required value types; validate the first provisional final shape (1PFS) against the VS; upon validating the first provisional final shape, identify the first provisional final shape as a first final shape (1FFS) and providing the first final shape.

In some embodiments, the system has a user device comprising a hardware processor and an interface to provide the user triggered event input.

In some embodiments, the system has one or more sensors or controllers to perform measurements for capturing one or more user gestures, wherein the user triggered event input is associated with the one or more user gestures.

In some embodiments, the event analytics server receives one or more user defined shape element, generates one or more EMOD associated with the one or more user defined shape element, and updates one or more ESOD associated with the one or more user defined shape element.

In some embodiments, the one or more event model object definition (EMOD) defines a nested, hierarchical, or recursive data element relationship within the system.

In some embodiments, the event analytics server provides the first final shape by transmitting and/or outputting the first final shape to a user interface.

In some embodiments, the event analytics server provides the first final shape by transmitting and/or outputting the first final shape to a secondary analytics server.

In some embodiments, the event analytics server determines that one or more secondary transformations is required for the user triggered event input and generates a second final shape by applying transformation logic to the first final shape.

In some embodiments, the system has an Event Definition Version Matcher Module for versioning validation using a hierarchical version identifier associated with the event analytics server, the ESOD and the one or more EMOD associated with the ESOD share one or more hierarchical elements within the version identifier.

In some embodiments, the event analytics server transmits the final shape to a tag manager component.

In some embodiments, the event analytics server receives a plurality of user triggered events and provides a plurality of first final shapes, wherein the plurality of user triggered events are triggered simultaneously.

In some embodiments, the event analytics server receives another user triggered event input, wherein the other user triggered event input is associated with user engagement and associates one or more context metadata values with the other user triggered event input to define another initial user triggered event input.

In some embodiments, the event analytics server associates the initial user triggered event input with a secondary analytics server type and secondary set of event logic comprising another event model.

In some embodiments, the event analytics server transforms the initial user triggered event input to match a set of protocols for the secondary analytics server and sends the transformed initial user triggered event input to the secondary analytics server.

In some embodiments, the system has a machine learning module for generating machine logic to implement one or more operations selected from the group of providing additional context metadata for the user triggered event input, monitoring validating of the first provisional final shape, determining common shape types, recommending changes to one or more EMOD, recommending changes to one or more ESOD, determining one or more errors requiring changes to one or more EMOD, determining one or more errors requiring changes to one or more ESOD, generating a new EMOD, and generating a new ESOD.

In another aspect, embodiments described herein provide non-transitory computer readable medium storing instructions executable by a processor to: receive a set of event logic comprising an event model defining more than one user triggered event; wherein the event model comprises a set of elements associated with the more than one user triggered event, wherein the set of elements provide: one or more event model object definition (EMOD) wherein the EMOD defines default values and/or a data element relationship within the system; one or more event standard object definition (ESOD) wherein the ESOD, defines a data model, shape, and event logic comprising an event category hierarchy and type associated with one or more user triggered event; one or more transformation objects definition (TOD) wherein the TOD, defines a model and transformation logic for determining a final shape using the ESOD and one or more EMOD; wherein the ESOD comprises one or more EMOD; wherein the TOD follows the shape of the ESOD and comprises one or more transformation paths, wherein the transformation path specifies a location associated with a value in the event standard object definition (ESOD) associated with a EMOD; receive a user triggered event input wherein the user triggered event input is defined by the event category hierarchy and type, and one or more values associated with the event, receive one or more context metadata value; associate the one or more context metadata value with the user triggered event input to define an initial user triggered event input; provide the initial user triggered event input to a listener module; identify, based on evaluating the event category hierarchy and type, the first associated ESOD and the first associated TOD for the user triggered event input; transform the values associated with the user triggered event input into a first provisional final shape (1PFS); generate a validation shape (VS) using the associated ESOD to define a required shape structure and required value types; validate the first provisional final shape (1PFS) against the VS; and upon validating the first provisional final shape, identify the first provisional final shape as a first final shape (1FFS) and providing the first final shape.

This summary does not necessarily describe the entire scope of all aspects of various embodiments described herein. Other aspects, features and advantages can be provided by various embodiments.

### BRIEF DESCRIPTION OF THE DRAWINGS

Embodiments of the disclosure will now be described in conjunction with the accompanying drawings of which:

FIG. 1 shows an example system architecture for event analytics according to embodiments described herein.

FIG. 2 shows an example system architecture for event analytics according to embodiments described herein.

FIG. 3 shows an example architecture of the relationship between event server module and definitions and shapes according to embodiments described herein.

FIG. 4 shows an example method associated with receiving inputs, evaluating events, transforming data associated with events, and outputting final shapes according to embodiments described herein.

FIG. 5 shows an example method and architecture associated with receiving a user triggered event and generating/providing a final shape according to embodiments described herein.

FIG. 6 shows an example method of further logic associated with refining a final shape according to embodiments described herein.

FIG. 7 shows an example user interface associated with and according to embodiments described herein.

FIG. 8 shows an example workflow and method associated with a business user and end user associated with and according to embodiments described herein.

FIG. 9 shows an example method associated with and according to embodiments described herein.

FIG. 10 shows a versioning logic example associated with and according to methods and embodiments described herein.

FIG. 11 shows an example schematic diagram illustrating the relationship between an event model object definition, event standard object definition, transformation objects definition, Verification Shape and Provisional Final Shape within the Event Model according to embodiments described herein.

### DETAILED DESCRIPTION

The methods and systems involve a hardware processor having executable instructions to provide analysis of one or more user triggered event in a user interface based on a modular versioned method of defining, aggregating, transforming, validating and event data and metadata associated with events.

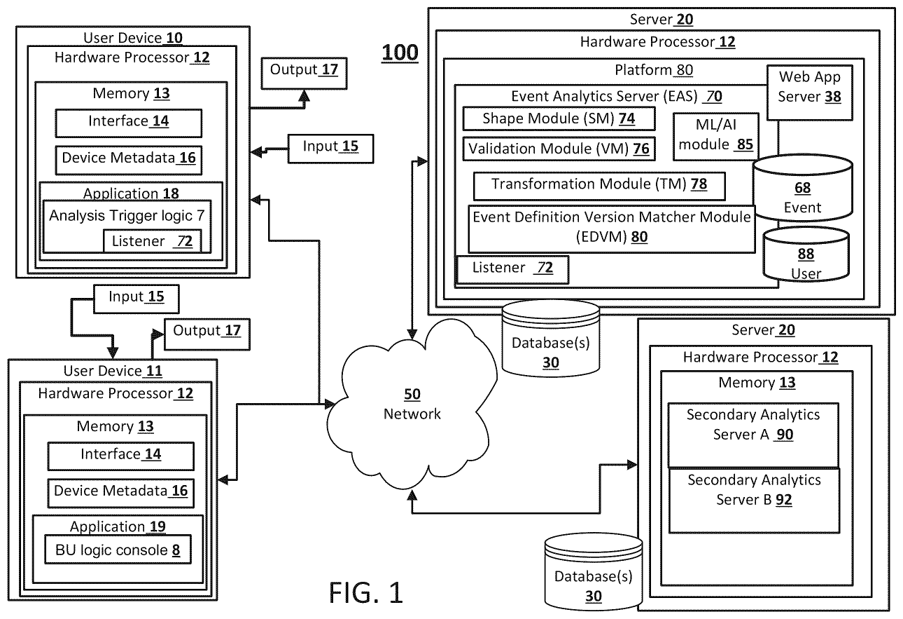

FIG. 1 shows an example embodiment of user event analytics (UEA) system 100 with a server 20 and one or more listener modules 72. The UEA system 100 has a set of event logic comprising an event model defining more than one user triggered event. The server 20 receives user triggered event input and context metadata value. The server 20 can process the initial user triggered event input using the listener module(s) 72. The listener module 72 can be a computer application that waits for user triggered events to occur and can then trigger or initiate an action relating to the event. The listener module 72 can operate asynchronously.

For the purpose of this disclosure, a user triggered event is a user input and/or behaviour captured using an input device within a user interface provided on a user device with a processor. There can be different types or categories of user triggered events. The user interface may be incorporated within a software application and/or website page.

A user input is an activity, which can be associated with a user, comprising event data which defines a behaviour, engagement or interaction with an application through a user interface. A user input can be associated with a user through user context metadata which can be retrieved immediately or shortly after the user event occurs through a listener device. A user input can be associated with gestures which are captured through a listener device located within the UAE system 100, or in some embodiments, the listener may be housed within an application run on the user device. Event data is one or more values, associated with a user event, which represent user defined shape elements that can be used as inputs within a universal shape structure based on instructions from the business unit console.

User events (which may also be referred to herein as user triggered events) can be associated with user activity at a computer device to capture and transmit data relating to the event. For example, a user can interact with an interface or application using input devices or peripherals of a computer device. User events can include data generated by tracked user actions at the computer device, for example. Embodiments described herein can receive data from a computer device associated with a user event to provide improved event detection, handling and analytics. For example, a server can receive data defining one or more user triggered events. A user event can be an action or occurrence triggered by a user and recognized by a server. Data relating to the user event can be measured, captured, collected, aggregated and processed. Data relating to the user event can be referred to as user event input data. The user event can trigger responses or other events or actions, for example.

Context data can be retrieved by a listener device when the event analytics system is triggered by a user event. The set of context data that is retrieved fluctuates based on the event and client that triggered the event analytics system. In some embodiments, the set of context data that is retrieved fluctuates based on the event and client that triggered the event analytics system can be defined by instructions input into the business user console. Context data can be retrieved from a user device, user model, machine learning module or a combination of the like. For example, context data may be retrieved from the user device when a user event is registered, which will include data such as timestamp, hostname, IP, navigational context, server, agent, locale, device capacity, a language, a region, a date, a time, a device display size, a size of a window displayed on a device, a processor speed, a Wi-Fi or data connection capacity or a device type. The context data may be augmented by a user model or machine learning module to further include updated data associated with the user and/or engagement evaluations related to the user such as user data related to user activity history, user preferences, user devices, user companion engagement response history, user companion history, user type, user preferences, user membership, user purchase history, user wellness history, and the like are associated with the user. In some embodiments, user metadata stored within the user model may include data generated by other users, or simulations of a specific user or types of users, with shared user characteristics.

User data and event data may overlap and already be merged prior to being received by the listener device, such that they can provide data such as user IP address, user-agent string (browser and operating system) being used, timestamp of trigger event, duration associated with trigger event, referrer URL, device type (such as a smartphone, tablet, or desktop computer), application or online version, operating system, browser type, time of visit, user interactions, and the like.

In accordance with some embodiments, the event model includes a set of elements associated with the user triggered event(s). The elements of the event model provide one or more event model object definitions (EMOD), one or more event standard object definitions (ESOD), and one or more transformation objects definitions (TOD). Upon receiving user triggered event input, the system 100 can evaluate the event category hierarchy and type and identify an ESOD and TOD for the user triggered event input. The system 100 can transform data values associated with the user triggered event input into a provisional final shape. The system 100 can generate a validation shape (VS) using the associated ESOD to define a shape structure and value types. The system 100 can validate the provisional final shape against the VS. If valid, the system 100 can identify the provisional final shape as a final shape. The system 100 can provide the final shape. In some embodiments, the UEA system 100 can use a number of ESODs/EMODs/TODs defined as a baseline and has the capacity to generate these programmatically. The UEA system 100 can process user triggered event input using a baseline set of ESODs/EMODs/TODs.

The system 100 can receives user triggered event input and transforms the input data into a ‘generic’ shape (relative to the system 100) so that the event input data looks the same from the perspective of the system 100 regardless of the source or origination of the input data. The system 100 can then process or analyze transformed events in a similar way as the event input data from different types of user triggered event input is transformed in a common way to generate ‘generic’ shapes for the system 100.

For the purposes of this disclosure, a data shape comprises value types and structure of one or more EMOD(s), defined by the event logic within an ESOD, which are organized based on an event category hierarchy and subtype. Within an ESOD, the one or more EMOD(s), either individually or through relational logic, represent an identifier which is associated with a data shape element such that event data can be mapped into a structure defined by the ESOD. Within the event analytics system, every registered event category and subtype is associated with a data shape through an ESOD stored within an Event Model. In order to generate a data shape, the user triggered event input must first be associated with an event category and, optionally, subtype. The event category and subtype identified will allow the event analytics system to retrieve an associated ESOD, which is paired with an associated TOD. TOD contains transformation logic which transforms the ESOD into a data shape containing values from the user triggered event input. The transformation logic parses the TOD in order to map event data to the location of the associated one or more EMOD(s) within an ESOD, and replace the default or undefined EMOD value with an event data value. The transformation performed by the TOD will provide a provisional final shape comprising the event data values organized into a data shape defined by the ESOD. The provisional final shape must be validated against the verification shape before it can become a final shape. The verification shape is generated by parsing the ESOD into a structure which can be processed by the event analytics system. Within the verification shape, a validation function is embedded which validates that the structure and value type within the provisional final shape matches the structure and value types defined by the ESOD.

An event model has a set of elements associated with the user triggered events. The elements of the event model provide one or more event model object definitions (EMOD), one or more event standard object definitions (ESOD), and one or more transformation objects definitions (TOD).

In some embodiments, event standard object definitions (ESOD) define a data model, shape, and event logic comprising an event category hierarchy and type associated with a user triggered event.

In some embodiments, event model object definitions (EMOD) define default values and/or a data element relationship within the system. The ESOD can include one or more EMODs.

In some embodiments, a transformation objects definition (TOD) defines a model and transformation logic for determining a final shape using the ESOD and one or more EMOD. A TOD can follow the shape of the ESOD and can includes one or more transformation paths. In some embodiments, a transformation path specifies a location associated with a value in the ESOD associated with an EMOD.

Secondary analytics server maintains a separate event logic system from event analytics server EAS 70. In some embodiments, secondary analytics server may be a proprietary external server or may be an internal server with a different event model than the EAS system 100. The secondary analytics server may use a different event model which may require a different (e.g., “non-generic” in relation to the system 100) FS. That is, EAS system 100 may transform user triggered event input into a ‘generic’ shape and then perform a second transformation, using the initial “generic” shape as an input, to achieve a “non-generic” final shape which can be provided to the secondary analytics server.

There is a need for improved systems, methods, and non-transitory computer readable medium with instructions stored thereon to generate, provide, update, and interact with user events and analysis processes associated with user events which the systems, methods, and non-transitory computer readable medium with instructions stored thereon disclosed addresses.

User event input triggers can be associated with gestures, or other navigational input, sensor data or electrical signals, for example. The input data can be captured in real-time or near real-time. In some embodiments, the method and system can involve performing measurements (e.g., using a sensor or controller) for obtaining the inputs characterizing user navigation related to a product depiction. For example, a user triggered event can relate to user navigation of an interface at a computer device. In some embodiments, the method and system provide a series of engagement evaluations which are associated with one or more activity of the user, one or more product depiction, with data being collected over a time duration.

In some embodiments, the user events and or user engagement evaluation is associated with and/or compared to user navigation, user purchase, user interaction with the EAS system 100, platform 80 or another platform (e.g., retail platform, exercise platform).

Embodiments described herein transmit signals to one or more controllers and/or sensors to preform measurements and receive an input such as, for example, user event input characterizing a user product exploration, navigation, purchase, associated with a user interaction with a user interface of a device. Embodiments described herein can involve using one or more sensors to perform measurements and receiving, from the measurements, input characterizing a user movement or location.

In some embodiments, the user engagement and/or user triggered event is evaluated, assessed, or estimated based on data and data models associated with the user, another user, a model of a user with specific characteristics, an activity, a model of an activity with specific characteristics, a skill level, a demographic, metadata associated with an activity, and the like. Models can be computer programs or code representations of machine learning or artificial intelligence processes that may be trained with datasets to improve product exploration and product purchase conversions. The system 100 can involve different types of computer models, such as event models and data models. For example, the system 100 uses an event model having a set of elements associated with the user triggered events. An event model can identify meaningful user triggered events within the system 100. As another example, an ESOD can define a data model relating to an event category hierarchy and type associated with one or more user triggered event. A data model can organize and standardize data values and relationships of data elements. A data model can be a specification describing structure of data elements and values.

Embodiments relate to methods and systems with non-transitory memory storing instructions and data records for product dimensions, product relationships, depicting product dimensions, product dimension characterization, product characterization, product depiction characterization, user engagement characterization, user characterization, and/or activity characterization. Embodiments relate to generating and providing a user within a navigational interface such as a GUI, virtual-reality environment, augmented reality environment, or the like, product depictions, related products, dimensions associated with one or more product, prioritization of related products, group of product dimensions, one or more axis of product dimensions, additional product information, and/or other information based on a calculated user engagement. This navigational interface and/or other information may include real-time or near real-time feedback related to specific user engagement, a preferred engagement-activity interrelation, assigning points to an engagement-activity interrelation, a combination, or the like. The feedback may provide user triggered event input, for example.

In an aspect, embodiments relate to methods and systems for an interactive platform such as, for example, an exercise platform, retail platform, social media community platform, augmented reality platform, virtual reality platform, mixed-reality platform or combination thereof. For example, FIG. 1 shows an example platform 80 as part of UEA system 100.

For the purposes of describing aspects of embodiments of the invention, a module, shape, model or object definition may be used to refer to a portion of application functionality, set of instructions, configuration or the like that is installed and or executed on a server and/or client device within the system. In some embodiments, these may be updated, modified, generated, regenerated or received based on input provided by a business user and/or ML AI module 85.

FIG. 1 shows an embodiment of user event analytics (UEA) system 100 that may generate and/or provide analysis results of one or more user events in response to an evaluation of inputs associated with user engagement.

User Event Analysis (UEA) system 100 may implement operations of the methods described herein. UEA system 100 has hardware servers 20, databases 30 stored on non-transitory memory, a network 50, and user devices 10. Servers 20 have hardware processors 12 that are communicatively coupled to databases 30 stored on the non-transitory memory and are operable to access data stored on databases 30. Servers 20 are further communicatively coupled to user devices 10 via network 50 (such as the Internet). Thus, data may be transferred between servers 20 and user devices 10 by transmitting the data using network 50. The user devices 10 include non-transitory computer readable storage medium 13 storing instructions to configure one or more hardware processors 12 to provide an interface 14 for collecting data and exchanging data and commands with other components of the system 100. The user devices 10 have one or more network interfaces to communicate with network 50 and exchange data with other components of the system 100. The servers 20 may also have a network interface to communicate with network 50 and exchange data with other components of the system 100.

A number of users of UEA system 100 may use user devices 10/11 to exchange data and commands with Servers 20 in manners described in further detail below. in some embodiments, only one User Device 10 may be present within System 100. However, in further examples, System 100 based on an input characterizing a user engagement and a user activity and/or location can include multiple user devices 10/11. In some embodiments, System 100 may be associated with and/or comprise Platform 80 which may include one or more regional or global retail platforms within Web App server 38. Web App Server 38 may be associated with multiple regions and may be accessed by thousands, or millions of users at the same time and such users may be associated with a regional platform or one or global platform.

The user devices 10 may be the same or different types of devices. The UEA system 100 is not limited to a particular configuration and different combinations of components can be used for different embodiments. Furthermore, while UEA system 100 shows two servers 20 and two databases 30 as an illustrative example related to generating and/or providing a final shape. UEA system 100 extends to different numbers of (and configurations of) Servers 20 and Databases 30 (such as a single server communicatively coupled to a single database). The Servers 20 can be the same or different types of devices.

The User Device 10 has at least one Hardware Processor 12, a Data Storage Device 13 (including volatile memory or non-volatile memory or other data storage elements or a combination thereof), and at least one communication or Network Interface 14. The User Device 10 components may be connected in various ways including directly coupled or indirectly coupled via a Network 50. The User Device 10 is configured to carry out the operations of methods described herein.

According to some embodiments, User Device 10 is a mobile device such as a smartphone, although in other embodiments User Device 10 may be any other suitable device that may be operated and interfaced with by a user. For example, User Device 10 may comprise a laptop, a personal computer, an interactive kiosk device, immersive hardware device, smart watch, smart mirror or a tablet device. User device 10, may include multiple types of user devices and may include a combination of devices such as smart phones, smart watches, computers, tablet devices, within system 100.

The User Device 10 may be a smart exercise device, or a component within a connected smart exercise system. Types of smart exercise devices include smart mirror device, smart treadmill device, smart stationary bicycle device, smart home gym device, smart weight device, smart weightlifting device, smart bicycle device, smart exercise mat device, smart rower device, smart elliptical device, smart vertical climber, smart swim machine, smart boxing gym, smart boxing bag, smart boxing dummy, smart grappling dummy, smart dance studio, smart dance floor, smart dance barre, smart balance board, smart slide board, smart spin board, smart ski trainer, smart trampoline, or smart vibration platform.

User in such systems may also input data and/or receive product depictions through different devices such as a camera, video camera, a microphone type sensor, a hologram projection system, an autostereoscopic projection system, virtual reality headset, an augmented reality headset, mixed reality devices, virtual reality devices, an augmented reality device, a metaverse headset, a haptic glove, a game controller, a haptic garment, which may or may not be integrated in other devices. User Device 10 comprise or connects to such input 15 and/or output 17 devices and/or component hardware in User Device 10.

Each hardware processor 12 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof. Memory 13 may include a suitable combination of any type of computer memory that is located either internally or externally.

Each network interface 14 enables User Device 10 to communicate with other components, to exchange data with other components, to access and connect to network resources, to serve applications, and perform other computing applications by connecting to a network 50 (or multiple networks) capable of carrying data. The communication or network interface 14 can enable User Device 10 to interconnect with one or more input devices, such as a keyboard, mouse, camera, touch screen, sensors and a microphone, or with one or more output devices such as a display screen and a speaker.

The memory 13 can store device metadata 16 which can include available metadata for factors such as memory, processor speed, touch screen, resolution, camera, video camera, processor, device location, haptic input/output devices, augmented reality glasses, virtual reality headsets. The system 100 can determine device capacity for a breath-move interrelation evaluation representation type by evaluating the device metadata 16, for example.

User device 10 receives (or couples to) one or more input 15 characterizing a user engagement. For example, the user engagement may be a user triggered event and/or provide user triggered event input to server 20. The input 15 can be sensor data or electrical signals, for example. In some embodiments, the input 15 can include sensors (or other devices) for performing measurements for obtaining sensor data or electrical signals characterizing a user navigation of product depictions.

EAS system 100 can involve different types of devices (e.g., user device 10 and user device 11) with different applications (e.g. application 18 and application 19) and interfaces. In some embodiments, application 18 on user device 10 may comprise analysis trigger logic 7 with a listener 72. In some embodiments, application 19 on user device 11 may comprise BU Logic Console 8 with a listener 72. In some embodiments, application 18 on user device 10 may comprise BU logic console 8. In some embodiments user device 10, 11 comprises different types of interfaces 14 such as user interfaces (UI). An example interface is a product depiction navigation (PDN) UI. In some embodiments, product depictions in PDN UI are generated by PDN generator on server 20 or another device. In some embodiments, product depictions (PD) and product depiction navigation components are stored in Server 20, for example Web App Server 38. In some embodiments, PD/PDN is stored in one or more Database 30. In some embodiments, the user triggered event relates to the PDN UI. In some embodiments, PDN UI can display prioritized product depictions determined based on the results from secondary analysis and input from ML/AI module 85 which identify combinations and products which should be prioritized for a user, or group of users. For example, secondary analysis on a user trigger event input consisting of conversion of a product can provide valuable data to business users on priority products for users sharing context metadata characteristics. Such a representation of prioritized product depictions enables the user to navigate through products and engage with product depictions in an engaging manner that enables improved product discovery. ML/AI module 85 can implement different operations for UEA system 100. ML/AI module 85 can generate and/or update machine logic to implement different operations for UEA system 100. For example, ML/AI module 85 can provide additional context metadata for the user triggered event input. As another example, ML/AI module 85 can monitor the validation (including the success of validations) of shapes and determine common shape types. As a further example, ML/AI module 85 can recommend changes to one or more EMOD and/or one or more ESOD. ML/AI module 85 can determine one or more errors requiring changes to one or more EMOD, and/or one or more ESOD. ML/AI module 85 can generate a new EMOD, and/or a new ESOD.

In some embodiments, Secondary Analytics Server A 90 and Secondary Analytics Server B 92 receive one or more inputs from EAS 70 characterizing a universal data structure. In some embodiments, Secondary Analytics Server A 90 comprises a tag manager which can utilize a third-party proprietary tool to output results. In some embodiments, Secondary Server B 92 comprises an internal tool which can receive non-universal data structures from EAS 70 through Network 50. In some embodiments, EAS 70 comprises a tag manager to output results.

User event analytics can structure event models into an event category and subtype using the characteristics which define the user event activity. Event category is a primary classification of the user event activity which will contain generic data fields which are present across all events categories. For example, generic data fields include timestamp, user session info, device type, hostname, user IP, server, agent and locale. Event subtype is a specific classification of the user event activity which contains a unique set of additional subtype specific metadata. For example, subtype specific metadata can include product ID, product name, product category, product views, component ID, interaction type, page URL, link clicks, link views, product price and the like.

UEA system 100 can provide greater adaptability and flexibility for event handling. For example, UEA system 100 can receive user triggered event input from different sources and transform the input into standard objects. UEA system 100 can generate new event standard object definitions and update the event standard object definitions mid-process. Every user event activity which is tracked by the user event analytics system can be bucketed or group into an event category or otherwise associated with an event category. The tracked user event activity can also have an associated subtype such as unique pageviews, product pageview, story pageview, default pageview, new visitors, and returning visitors, user information gathering, conversion tracking wherein a user has taken an action such as signing up for a newsletter, purchasing a product or the like, user engagement with an advertisement as defined by tracking views, clicks, play duration, view duration, wishlist, search strings, subscription completed, product customization selected, chat duration, setting changes, installing applications, content viewed, recommended products selected and the like.

For example, a first event category can define pageview events. Events having a category of pageview may have subtypes which can include unique pageviews, product display page viewed, and recommended products viewed. A second event category can define a component interaction event. Events having a category of component interaction may have a subtype which can include button click on homepage, add to bag click, add to wishlist click, product customization selected, initiate chat, search completed, application installation, video started, and the like.

Context data and or event data may provide such data as user IP Address, user-agent string (browser and operating system) being used, timestamp of trigger event, duration associated with trigger event, referrer UR, device Type (for example a smartphone, tablet, or desktop computer), application or online version, operating system, and the like, browser Type, time of visit, user interactions (clicks, scrolls, form submissions, and combinations), and the like.

Application 18, 19 and/or user interface 14 may be represented using a Graphical User Interface (GUI), Tangible User Interface (TUI) Natural User Interface (NUI), Augmented Reality (AR), Virtual Reality (VR), other UI representation modes or a combination. In some embodiments, within a standard GUI, TUI, NUI, or for example virtual reality, augmented reality, projection screen and the like. User generated events may be triggered through an input to interactable user interface 14, for example a touch screen input, a scroll gesture, a click on an element displayed on a graphical user interface, a gesture indicating an interaction with an element within a virtual reality or augmented reality environment, or the like. In some embodiments, a series of user actions may constitute an event trigger. For example, in some embodiments, a user may click on a product to view, drag the product representation to a cart, click a button labeled purchase, and provided payment information, to trigger a composite purchase event.

In some embodiments, there are provided systems, methods, and executable instructions for synchronizing user event input. This synchronization may include a means of user calibration, date-time stamp verification and alignment, establishing master-slave sensor relationships, using a timing transport protocol such as IRIG (Inter-Range Instrumentation Group), GPS PPs (Global Positioning System Pulse Per Second), NTP (Network Time Protocol), EtherCAT (Ethernet for Control Automation Technology) PTP V2 (Precision Time Protocol) and the like to ensure user event synchronization.

The user device 10 and/or output device 17 may be a device such as a smart phone, smart exercise mirror, or a virtual reality connected device. The user device 10 can capture data relating to the user triggered event.

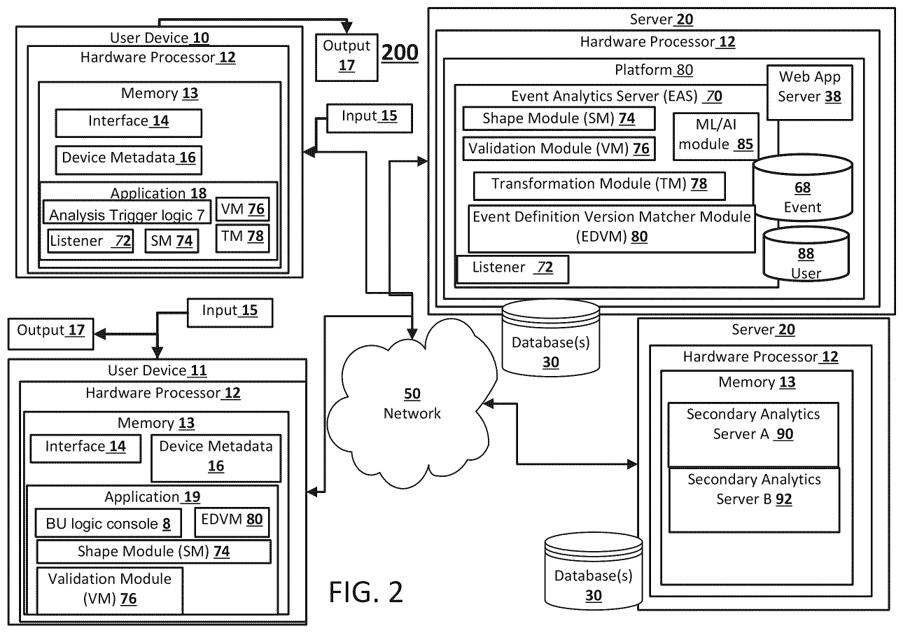

Turning to FIG. 2, an example system architecture is shown for event analytics in which the event analytics system 200 is decentralized.

Within EAS 200, Server 20 comprises Hardware Processor, which further comprises Platform 80. Within Platform 80, the User Model 88 and Event Model 68 will contain event data and user data which can be provided to Hardware Processor 12 within User Device 10. In some embodiments, EAS 70 may contain a Shape Module 74, Validation Module 76, Transformation Module 78 and Listener 72. In further embodiments, EAS 70 will only contain the Web App Server 38, Event Model 68, User 88 and ML/AI Module 85, as all other components will be hosted within User Device 10 and User Device 11. In this embodiment, EAS 70 primarily operates as a repository and/or database which can be used to pull data, event logic and updates, while User Device 10 and User Device 11 perform the event analytics and compiling of results.

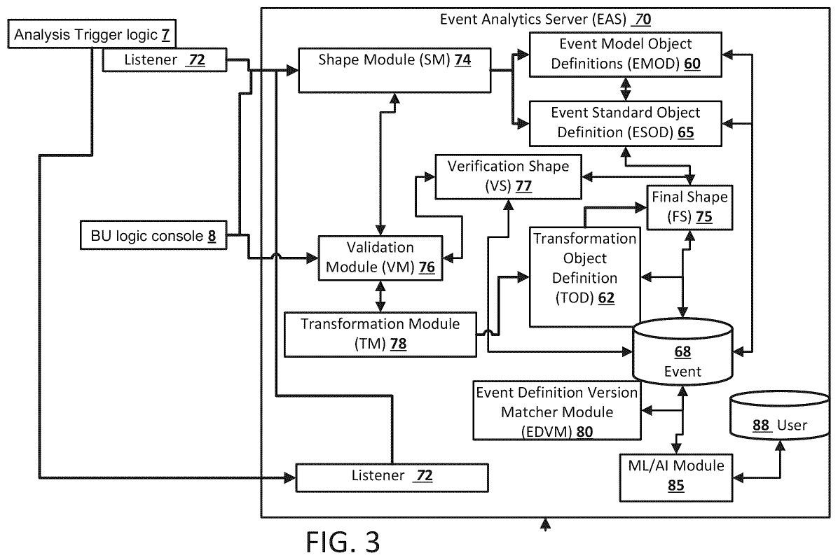

There will now be described methods for generating the verification shape and final shape and/or provisional final shape. Methods, and aspects or operations of methods are shown generally in FIGS. 3-8 which show diagrams of the steps that may be taken to perform event analytics.

The steps shown in FIGS. 3-9 are exemplary in nature, and, in various embodiments, the order of the steps may be changed, and steps may be omitted and/or added without departing from the scope of the disclosure. Methods can perform different combinations of operations described herein to provide or generate one or more final shape(s).

Turning to FIG. 3, shows an example architecture of the relationship between event server module and definitions and shapes according to embodiments described herein.

Analysis Trigger Logic 7 initiates the process, upon identifying an event generated by a user, of providing a user triggered event input to the Event Analytics Server (EAS) 70. The EAS 70 is comprised of instructions and models stored on the Hardware Processor 12. In some embodiments, EAS 70 may be decentralized and stored within User Device 10. The Analysis Trigger Logic 7 receives event data from the Listener 72 and determines whether an event category hierarchy and subtype are present in the event data. The event category hierarchy is considered the parent type of the user triggered event input, and can be either a single event category or a hierarchy of event categories which are ordered in a structured taxonomy, for example species, genus, family, order, class, division, domain. Event subtype is nested within an event category and is what is initially used by the Listener 72 to determine the one or more ESOD 65 and TOD 70 that is associated with the user triggered event input. If no subtype is identified, then Listener will use the parent type (i.e., category) to determine the ESOD 65 and TOD 70 that is associated with the user triggered event input. Every event category will have a default ESOD 65 and TOD 70 stored within the Event Model 68, which is used when no subtype is identified.

In some embodiments, the Analysis Trigger Logic 7 will not provide the event data to the EAS 70, effectively terminating the process, if the user event was performed on an application or device which is not supported by the EAS 70 (i.e., non-compliant client). In some embodiments, Analysis Trigger Logic 7 may operate through coded instruction maintained within the Application 18 or Web App Server 38, which run tracking functions such as web beacons or tracking pixels, to track user engagement and behaviours within Web App Server 38 or Application 18.

Event categories can include, for example, pageview events and component interaction events. Event subtype can include product display page, button click on homepage, button click on product filters, add to bag click, add to wishlist click, complete purchase click, complete subscription click, initiate chat click, link viewed, recommended products viewed, and the like.

Listener 72 comprises a module for receiving context metadata and event data from user device 10/11. Listener 72 will monitor signals relating to both the user interaction with the user device 10/11 and the display of the user device 10/11. For each event category created by the BU Console Logic and registered within EAS 70, a set of tracking logic will be created within Listener 72 for each registered event category, which will track all events falling within the associated event category (i.e., a user triggered event input). When Listener 72 identifies that a user triggered event input has occurred which falls within a registered event category, Listener 72 will retrieve the event data and label the user triggered event input with the event category associated with the tracking logic which retrieved the user triggered event input. Listener 72 will then communicate with Shape Module 74 to identify the subtype associated with a user triggered event input using the event data retrieved by Listener 72. If a subtype is identified for the user triggered event input, Listener 72 will label the user triggered event input with the subtype, at which point the user triggered event input will have both an event category and subtype label. Based on the subtype identified for the user triggered event input, tracking logic, associated with the identified event category, will cause Listener 72 to retrieve context metadata associated with the user triggered event input. Listener 72 will merge the context metadata with the event data contained within the user triggered event input. Listener 72 will then provide the user triggered event input, including the event category and subtype, to the EAS 70, through the Shape Module 74 and Transformation Module 78.

A subtype will be defined by a unique subset of context metadata, which is collected, through the tracking logic associated with the event category identified within Listener 72, in addition to the common data fields collected for all event categories. In some embodiments, every event category will have a default subtype which is defined by default context metadata retrieved from the user triggered event input. In some embodiments, the non-default subtypes within an event category will include both a unique subset of context metadata and the default context metadata inherited from the default subtype. In some embodiments, the context metadata retrieved by Listener 72 varies based on the device and application in which the user event occurred. In some embodiments, the ML/AI Module 85 will provide additional context metadata which will be used to augment the set of context metadata collected by Listener 72.

The organization of user triggered event inputs into an event category hierarchy and subtype provides a business user the adaptability to modify or create event categories, or subtypes within an event category, during operation of the event analytics system. A business user is able to input instructions into a user interface, without having to made direct modifications to the underlying code, to create new shape elements which can be processed by EAS 70 into event models defining event categories or subtypes.

The EAS 70 will transform the user triggered event input into a universal data structure which can be shared amongst business users across multiple regions and platforms. Within the EAS 70, shape module 74 can create EMOD(s) 60 based on instructions received through Network 50. In some embodiments, within the EAS 70, shape module 74 can create EMOD(s) 60 based on instructions received from BU Logic Console 8, received through Network 50. Shape Module 74 may generate or modify one or more ESOD 65 based on one or more new EMOD(s) 60. Shape Module 74 is coupled to Event Model 68, and the defined EMOD(s) 60, ESOD 65 and TOD 70 are stored within Event Model 68. Event Definition Version Matcher Module 80 tracks modifications to Event Model 68 and validates, when an ESOD 65 and TOD 70 is retrieved from Event Model 68, that real-time or near real-time data are reflected in the event or transformation logic for the retrieved ESOD 65 and TOD 70. In some embodiments, event Definition Version Matcher Module 80 tracks modifications to Event Model 68 and validates, when an ESOD 65 and TOD 70 is retrieved from Event Model 68, that real-time or near real-time instructions from BU Logic Console 8 are reflected in the event or transformation logic for the retrieved ESOD 65 and TOD 70. Transformation Module 78 is coupled to Event Model 68 and parses the one or more TOD 70 in order to effect the transformation into a provisional final shape, which can then be provided to Validation Module 76. Validation Module 76 generates the Verification Shape 77 by parsing the ESOD 65 received from Event Model 68, and runs the Verification Shape 77 against the provisional final shape. Upon a validating the provisional final shape, Validation Module 76 provides the final shape to Database(s) 30, ML/AI Module 85 and User Device 11, through Network 50.

In some embodiments, the EAS 70 can be decentralized and stored on User Device 10/11.

User 88 is a model that provides context metadata, relating to one or more users, to one or more user triggered event inputs and to the ML/AI Module 85. User Model 88 includes processor-executable instructions or processor-readable data which when executed cause Hardware Processor 12 to receive a set of event inputs and retrieve context metadata that is associated with the user and event inputs. In some embodiments, the User Model 88 will establish a profile of the user based on their past and current interactions. User Model 88 may augment the context metadata available for a user trigger event input by providing the EAS 70 with metadata associated with the user. In some embodiments, User Model 88 will provide the ML/AI Module 85 with stored context metadata related to the user, and the ML/AI module 85 will provide additional context metadata to the Listener 72 for a user, or types of users, with shared user characteristics. In some embodiments, the User Model 88 will track updates in event inputs and compare the updated information with stored information, and provide this updated information to the ML/AI Module 85. For example, ML/AI Module 85 can be prepopulated with metadata based on stored data of past engagement from groups of users having related context metadata characteristics. The prepopulated metadata in the AI/ML Module 85 will then be updated with the context metadata provided by User Model 88 specific to the user based on the users past and current engagement. In some embodiments, User Model 88 may provide event data, such as when navigational context data associated with a user is provided, due to navigational context metadata and event data overlapping, since both may be characterized as an input or user interaction with a UI.

User context metadata may be updated with data associated with the user and/or engagement evaluations related to the user. In some embodiments user data related to user activity history, user preferences, user devices, user companion engagement response history, user companion history, user type, user preferences, user membership, user purchase history, user wellness history, and the like are associated with the user. In some embodiments, user metadata may include data generated by other users, or simulations of a specific user or types of users, with shared user characteristics. ML/AI module 85 can receive the content metadata for processing. ML/AI module 85 module can monitor the success of shape validations, and the most common shape types. ML/AI module 85 can propose EMOD/ESOD changes and/or flag VS error trends requiring ESOD modification. In some embodiments, ML/AI module 85 can generate these new EMOD/ESOD based on its generated logic.

Event 68 is a model that stores sets of EMOD, ESOD and TOD associated with a user triggered event. Event 68 includes processor-executable instructions or processor-readable data which when executed cause Hardware Processor 12 to interpret an event category and subtype and define required shape structures and value types associated with a specified combination of event category and subtype. Event 68 receives one or more defined EMOD(s) 60, ESOD 65 and TOD 70 from Shape Module 74. Within Event Model 68, one or more ESOD 65 and TOD 70 are associated with every event category and subtype which has been registered by a business user using the business user interface housed within User Device 11. In some embodiments, Event 68 receives augmented event data from the ML/AI Module 85 which is used to create new EMOD(s) 60 and modify one or more ESOD 65 and TOD 75.

ML/AI Module 85 is a predictive computer model which uses product and user datasets to provide one or more of the User Model 88 and Event Model 68 with user metadata, context metadata and event data. In some embodiments, the user and context metadata generated by the ML/AI Module 85 for the user model 88 may include simulations of a specific user or types of users, with shared user characteristics. In some embodiments, the ML/AI Module 85 will update event logic and transformation logic to reflect drift within the event data or to capture more event inputs. In some embodiments, the updated event logic and transformation logic generated by the ML/AI Module 85 is used to improve the secondary analysis performed by third party. In some embodiments, the ML/AI Module 85 training datasets include data relating to user feedback, user engagement, user purchases, user activity engagement, user engagement feedback, user physiological activity engagement, purchases resulting from an engagement, PDN representation type feedback, PDN representation type engagement, activity participation resulting from a PDN representation, invalid provisional final shapes, provided final shapes, user event inputs, context metadata retrieved, results from secondary analytics, business user instructions, and event category and subtypes identified.

BU Logic Console 8 comprises instructions from the BU which define the one or more EMOD(s) 60 and modify the one or more ESOD and associated TOD which will be applied to the user triggered event input. In some embodiments, the BU Logic Console 8 provides the SM 74 and VM 76 with one or more user defined shape elements which are used for creating or updating ESOD 65 and TOD 70. The Shape Module 74 associates one or more EMOD(s) 60 with the user defined shape element based on the default values and data element relationships that could exist within the one or more user defined shape elements. The ESOD 65 and associated TOD 70 for an event category hierarchy and subtype will be modified to reflect the updated default values and data element relationships available from the EMOD(s) 60 associated with the user defined shape element.

Shape Module 74 receives event data and generates/modifies one or more ESOD 65, and associated one or more EMOD(s) 60, based on a defined data shape that should be achieved. For every event category and subtype registered by the BU Logic Console 8, an ESOD 65 and associated TOD 70 exists within the Event Model 68 which can be retrieved. In some embodiments, shape Module 74 receives instructions from the BU Logic Console 8 and generates/modifies one or more ESOD 65, and associated one or more EMOD(s) 60, based on a defined data shape that should be achieved. For every event category and subtype registered by the BU Logic Console 8, an ESOD 65 and associated TOD 70 exists within the Event Model 68 which can be retrieved. When a business user identifies an event category and subtype which contains event data that is of interest, the Shape Module 74 will generate a new set of one or more EMOD(s) 60 which can then be used to create a new ESOD 65 structure to capture the event data of interest. Shape Module 74 receives from Listener 72 the user triggered event input and uses the event category associated with the tracking logic from Listener 72 which retrieved the user triggered event input to process an event category and subtype.

Event Model Object Definitions (EMOD) 60 is a default value or data element relationship which represents an identifier used by the ESOD 65 and TOD 62 to define a shape. In some embodiments, EMOD(s) 60 can have a hierarchal, nested or recursive data structure. One or more EMOD(s) 60 can be associated with an ESOD 65, depending on the event category hierarchy and subtype associated with the ESOD 65. The EMOD(s) 60 represents the valid data types which have been defined by the BU Console Logic 7, with each registered event category hierarchy and subtype having one or more EMOD(s) 60 which can be called by the TOD 62 to generate a generic data shape. Every data field within an event category and subtype will an associated EMOD(s) 60, such that there will be common EMOD(s) 60 associated with the common data fields of an event category, default EMOD(s) 60 associated with default subtypes within an event category, and specific EMOD(s) 60 associated with the specific subtypes within an event category.

In some embodiments, when a drift in data is measured, requiring modifications to the event category hierarchy or subtypes associated with user triggered event inputs, new EMOD(s) 60 can be created. In some embodiments, modified or new EMOD(s) 60 can be generated by the AI/ML Module 85. When the ESOD 65 is transformed into a first provisional final shape, the TOD 62 will call the associated EMOD(s) 60 to obtain the data values from the user triggered event input.

Event Standard Object Definition (ESOD) 65 comprises an event logic which structures one or more EMOD(s) 60 to create a data shape. The event logic within ESOD 65 defines the structure and value type which will be used for the final shape, based on the event category and subtype of the user triggered event input. In some embodiments, event logic for ESOD 65 can be provided by ML/AI Module 86. In some embodiments, event logic for ESOD 65 is provided by the BU Logic Console 8. Event logic can be generated such that the one or more shape elements associated with one or more EMOD(s) 60 within the ESOD 65 will provide event data values from the user triggered event input that define the event category and subtype. ESOD 65 can contain relational logic which may create a structure containing nested, hierarchical or recursive EMOD(s) 60 logic.

Transformation Module 78 initiates the process of applying the Transformation Object Definition 62 to the ESOD 65. Transformation Module 78 parses the one or more TOD 70 in order to effect the transformation of ESOD 65 into a provisional final shape. Every ESOD 65 has an associated TOD 70 stored within Event Model 68. TOD 70 follows the shape of the associated ESOD 65 and maps object keys or subkeys, containing the input data path, from the user triggered event input to the EMOD(s) 60 within the ESOD 65 structure. TOD 70 will replace the default, undefined or data element relationships defined by one or more EMOD(s) 60 within ESOD 65 with an event data value which is output according to the structure and value type defined by ESOD 65.

Validation Module 76 initiates the process of providing a Verification Shape 77 upon receiving the event category hierarchy and subtype associated with the user triggered event input from the Listener 72.

Verification Shape 77 can be generated from ESOD 65. Verification Shape 77 can be provided by Event 68 based on the event category hierarchy and subtype of the user triggered event input. Event 68 will receive the ESOD 65 which has been associated with the event category hierarchy and subtype identified by Listener 72. In one embodiment, Verification Shape 76 is generated based on an abstraction of the specific logic of ESOD 65 to define a shape and/or data types associated with elements within the ESOD. In an embodiment, Event 68 verifies that a Verification Shape 77 exists for the event category hierarchy and subtype. If no Verification Shape 77 exists for the combination of event category hierarchy and subtype associated with the user triggered event input, an error message will be provided. If the ESOD 65 is parsed and a Verification Shape 77 is found, then the Validation Module 76 can compare the Verification Shape 77 with the provisional final shape to determine if the data structure and value types match. If the First Provisional Final Shape is validated, then the data shape of the First Provisional Final Shape will become Final Shape 75. If validation is not successful, then an error will be thrown which will identify the error within the provisional final shape and user triggered event input.

Final Shape 75 is generated upon a successful validation of the First Provisional Final Shape against the Verification Shape 77. Final Shape 75 has the identical data structure of the validated first provisional final shape. In some embodiments, upon Final Shape 75 being generated, it can be provided to business user interfaces. In a further embodiment, Final Shape 75 can be provided to a secondary analysis server which will use the Final Shape 75 as the new user triggered event input and further transformations can be performed to achieve a data shape associated with a secondary event category and subtype.

Event Definition Version Matcher Module (EDVM) 80 performs versioning validation by identifying the version identifier for an ESOD 65, one or more EMOD(s) 60 associated with the ESOD 65, and associated TOD 70 within the EAS 70. EDVM 80 will determine, when an ESOD 65 and associated TOD 70 are retrieved from Event Model 68, that all event model components share one or more elements within the version identifier.

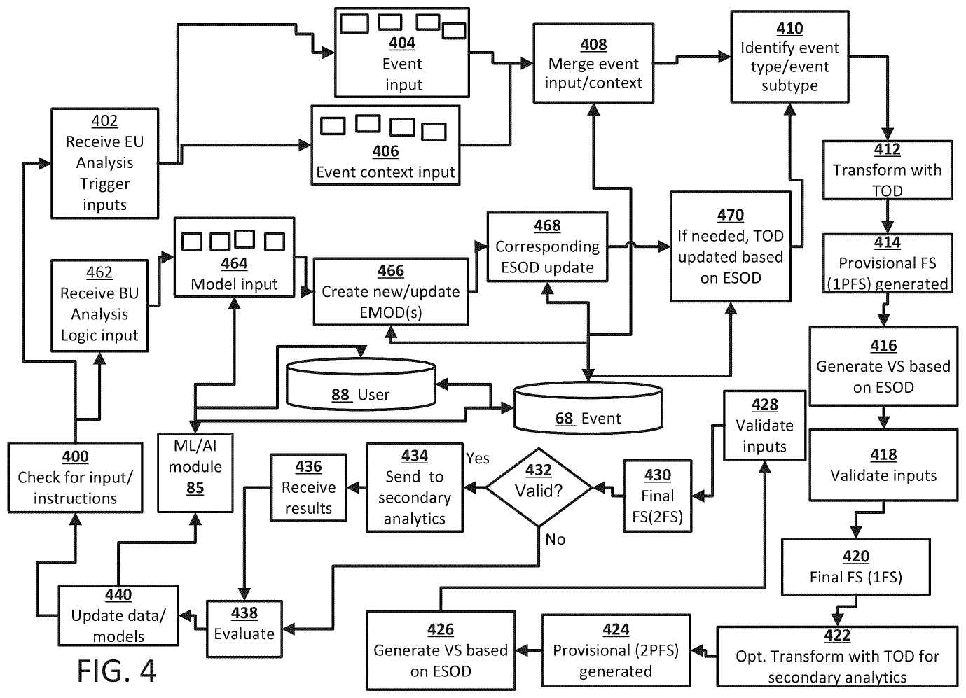

FIG. 4 shows an example method associated with receiving inputs, evaluating events and transforming data associated with events, and outputting one or more final shapes according to embodiments described herein. The inputs received by the example method characterize a user event containing user data, a context containing context metadata associated with the user and business user instructions comprising an EMOD input. In some embodiments, sensor input associated with user triggered events and/or engagement is evaluated.

Check for Input/Instructions 400 comprises the Listener 72 assessing controller and sensor inputs for user events and business user instructions. Listener 72 may receive event data to instruct Listener 72 to track specified user events, retrieve specified context metadata, modify the event logic associated with one or more ESOD/TOD and/or create new EMOD(s). In some embodiments, listener 72 may receive business user instructions from the BU Logic Console 8 which will instruct Listener 72 to track specified user events, retrieve specified context metadata, modify the event logic associated with one or more ESOD/TOD and/or create new EMOD(s). Listener 72 may receive user event inputs from one or more controller(s) and sensor(s). In some embodiments, sensors and controllers may measure inputs relating to the use of a touch screen, headset, input devices, voice navigation audio input, gesture detection sensors, and the like.

Sensors may be any one of such as accelerometers, gyroscopes, Global Positioning System (GPS) sensors, camera sensors, video motion sensors, inertial sensors, IMU (inertial measurement unit) head tracker, Passive Infrared (PIR) sensors, active infrared sensors, Microwave (MW) sensors, area reflective sensors, lidar sensors, infrared spectrometry sensors, ultrasonic sensors, vibration sensors, echolocation sensors, proximity sensors, position sensors, inclinometer sensors, optical position sensors, laser displacement sensors, multimodal sensors, and the like may be used to make such measurements. A single sensor device may be used to measure both physiological engagement and movement.

Receive EU Analysis Trigger Inputs 402 comprises Listener 72 detecting a trigger event, through sensors and controllers which measure and receive inputs, characterizing a user product exploration, navigation or purchase associated with a user interaction with a user interface. A trigger event involves user event input that is being tracked by Listener 72 based on instructions. For example, in some embodiments, a trigger event is any user event input which is being tracked by Listener 72 based on instructions provided by BU Logic Console 8. In some embodiments, user event input events are tracked based on one or more specific identifiers and type associated with the event. Events being tracked by Listener 72 may be standard and/or customized (i.e., for specific business users) event types. The user event input data can be captured by Listener 72 in real-time or near real-time. A user event input can comprise one or more of a user movement, interaction/engagement or location. For example, a user event input which will be registered as a trigger input can be associated with gestures, or other navigational input, sensor data or electrical signals. When a trigger input occurs, the Event Analytics Server will register a user triggered event input, which is composed of the Event Input 404 and Event Context Input 406. In some embodiments, the Event Analytics Server may receive more then one trigger events simultaneously.

Receive BU Analysis Logic Input 462 comprises instructions from a business user which are implemented through a business user interface. Business user logic can instruct the Shape Module 74 to generate new EMOD(s) 60 and modify one or more ESOD 65 and associated TOD 70. New or modified event models may be generated based on business user instructions to reflect new categories or subtypes of interest, new platform or user engagement possibilities, drift within data or errors within the current event models. Instructions from Receive BU Analysis Logic Input 462 can be implemented within EAS 70 in real-time or near real-time.

Event Input 404 comprises the user event data, associated with a user, which is used for the user triggered event input received by Listener 72. Event Input 404 can be any evaluable user activity with a user interface. For example, Event Input 404 can occur when a user performs an action comprising an event such as page load, page view, view content, link click, link hover, form completion, form partial completion, add to cart, add to wishlist, button click, checkout, page scroll, video view, application install, subscribe, login, purchase, search, ad click, button click, add payment info, complete registration, contact, customize product, donate, play audio, audio location, play video, video location, find location, logout, initiate chat conversation, end chat conversation, lead, initiate checkout, schedule, start trial, submit application, change setting, and combinations.

Upon identifying a user triggered event input, Listener 72 will retrieve context metadate associated with the user event input.

Event Context Input 406 comprises context metadata related to one or more of the user, retail environment, device or platform used, URL access or navigational context, associated with the user event input. Listener 72 is configured to collect a set of context metadata for a user trigger event based on the event category and subtype associated with the user triggered event input. Context metadata can include timestamp, hostname, IP, navigational context, server, agent, locale, device capacity, a language, a region, a date, a time, a device display size, a size of a window displayed on a device, a processor speed, a Wi-Fi or data connection capacity or a device type. Navigational context may include user navigational path, search history, category/characteristics selection, a special offer, a promotion, general or demographically specific logic related to navigation, conversion history, purchase history, wishlist history, or the like, associated with all users, a subset of users, a group of users, a specific user or the intersecting values associated with such measures. Navigational context may also include generalized models and data related to user navigation. Generalized context models may be based on users within a region, demographic, access time frame, time stamp, purchase engagement criteria, membership level, the like, or combinations. In some embodiments, metadata related to the user may be retrieved from User Model 88. In further embodiments, the context metadata is modified and/or improved based on ML or AI improvements to the event/user model.

User context metadata may be updated with data associated with the user and/or engagement evaluations related to the user. In some embodiments user data related to user activity history, user preferences, user devices, user companion engagement response history, user companion history, user type, user preferences, user membership, user purchase history, user wellness history, and the like are associated with the user. In some embodiments, user metadata may include data generated by other users, or simulations of a specific user or types of users, with shared user characteristics. As noted, ML/AI module 85 can receive the content metadata for processing user triggered event input. For example, ML/AI module 85 module can monitor the success of shape validations, and the most common shape types. ML/AI module 85 can propose EMOD/ESOD changes and/or flag VS error trends requiring ESOD modification. In some embodiments, ML/AI module 85 can generate these new EMOD/ESOD based on its generated logic.

When a user triggered event input is retrieved, a set of data will be retrieved, including context data, which is common across all event categories. This can include for example timestamp, user session info, device type, hostname, user IP, server, agent and locale. Each common data field will be associated with one or more common EMOD(s) 60 within the structure of ESOD 65. For every event category registered within EAS 70, a default subtype will exist which defines a set of generic context metadata which will be retrieved by Listener 72. Each generic context metadata value will be associated with one or more default EMOD(s) 60 within the structure of ESOD 65. An event category can have one or more specific subtypes which defines a set of specific context metadata values which will be retrieved by Listener 72. In some embodiments, specific subtypes can also inherit the context metadata retrieved for the associated default subtype. Each specific context metadata value will be associated with one or more specific EMOD(s) 60 within the structure of ESOD 65.

For example, subtype default or specific metadata can include a token, ID, machine executable code, user authentication details, device metadata, location, activity or class associated with the user, activity type, class type, date, time, region, local weather and other regional factors, user device hardware details, system details, membership level details, user points or rating, user activity history, user purchase history, user navigational history, user preferences, file encryption standards, music, audio, lighting conditions, a combination thereof, and the like.

In some embodiments, Event Input 404 and User Context Input 406 may overlap, such as when the context metadata received at 406 contains navigation context. In this embodiment, as some of the navigational context may overlap with Event Input 404, the Event Input 404 may be used as a value within the event data analyzed by the Event Analytics Server.

Merge Event Input/Context 408 comprises combining the Event Context Input 406 with the Event Input 404 to comprise a single input. When the Event Input 404 is received by the Listener 72 and registered as a user triggered event input, Listener 72 will initially input default context metadata into the Event Input 404, based on modelling from User Model 88. The default context metadata will be replaced with the Event Context Input 406 and the merged event and context data will comprise the user triggered event input provided to the EAS 70. In some embodiments, the user triggered event input already contains context metadata when it is retrieved by Listener 72.

Identify Event Type/Event Subtype 410 comprises Listener 72 determining, based on the tracking logic and instructions from Shape Module 74, one or more event category hierarchy and subtype associated with one or more user triggered event input. The event category hierarchy and subtype will determine the one or more ESOD 65 and TOD 70 associated with the user triggered input event. First, Listener 72 checks if the user triggered event input contains a key for an event subtype which can be used to retrieve one or more associated ESOD 65 and TOD 70 from Event Model 68. If no event subtype is found within the user triggered event input, then Listener 72 will retrieve, from Event Model 68, one or more default ESOD 65 and TOD 70 associated with the event category hierarchy.

Transform with TOD 412 comprises the Transformation Module 78 using the TOD 70 which is associated with the ESOD 65, retrieved at step 410, to parse the ESOD 65 into a First Provisional Final Shape. The TOD 70 maps data values from the user triggered event input to a location within ESOD 65, containing one or more EMOD 60 associated with a data element. TOD 70 and associated ESOD 65 is selected by the Event Model 68 based on the event category hierarchy and subtype that was identified by the Listener 72. The TOD 70 is associated with an ESOD 65 within the Event Model 68, such that all valid event category hierarchy and subtype combinations will be associated with a previously defined one or more TOD 65 and ESOD 70 pairing stored within Event Model 68. If a user triggered event input does not have a previously defined TOD 70 associated with the event category hierarchy and subtype identified by the Listener 72, then an error message will be sent. In some embodiments, one or more TOD 70 and associated ESOD 65 are created and stored in the Event Model 68 based on instructions to create one or more EMOD(s) 60. In some embodiments, one or more TOD 70 and associated ESOD 65 are created and stored in the Event Model 68 by the BU Logic Console 8 based on instructions to create one or more EMOD(s) 60. The one or more EMOD(s) 60 can be used to create new event logic and transformational paths linking one or more EMOD(s) 60 to one or more data element in the user triggered event input. If no TOD 70 is found in the Event Model 68 for the event category hierarchy and subtype identified for the user triggered event input, then an error message is sent to Hardware Processor 12.

Provisional FS (1PFS) Generated 414 comprises a data shape generated by parsing the one or more TOD 70 associated with a user triggered event input to generate a universal data structure comprising the elements from the user triggered event input mapped to the event logic within the ESOD. The generated data shape is provisional as it has not been validated against the Verification Shape 77 by the Validation Module 76.

Generate VS based on ESOD 416 is performed by taking the one or more ESOD 65 associated with the event category hierarchy and subtype identified by Listener 72, and parsing the one or more ESOD 65 to create a provisional data shape. If no Verification Shape 77 is found in the Event Model 68 for the one or more ESOD 65, then an error message is sent to Hardware Processor 12.

Validate Inputs 418 comprising the Validation Module 76 comparing the Verification Shape 77 to the first provisional final shape using a validation function embedded within the Verification Shape 77. In some embodiments, the validation function comprises a regular expression tool which determines whether the output for the first provisional final shape match a valid data value, data type or structure. If the Validation Module 76 determines that the first provisional final shape is valid then it will become Final FS (1FS) 420. The first Final Shape 75 received by Final FS (1FS) 420 will be provided to the business user through a user interface. In some embodiments, the Final Shape 75 will be provided to a tag manager. If the Validation Module 76 determines that the first provisional final shape is not valid, then an error message will be sent which identifies the error within the ESOD 65 and user triggered event input.

Opt. Transform with TOD for Secondary Analytics 422 comprises Hardware Processor 12 determining if a secondary analysis is required based on the event logic within the one or more ESOD 65 used to generate first Final Shape 75. If Hardware Processor 12 determines that a secondary analysis is required for a first Final Shape 75, then a secondary one or more ESOD 65 and associated TOD 70 will be identified using a secondary event category and subtype that is separate from the event category hierarchy and subtype identified for the user triggered event input. The secondary one or more ESOD and associated TOD 70 are retrieved from the Event Model 68. The secondary analysis allows business users to transform the universal data shape of the first Final Shape 75 into a non-universal shape containing a set of values or structure which is conducive to their business needs. In some embodiments, the secondary ESOD 65 may contain job options which provide a business user with the ability to customize how they would like the results from the secondary analysis presented or collected, or the platform, users or location which should be excluded from the secondary analysis.

Provisional (2PFS) Generated 424 comprises transforming the first Final Shape 75, using transformation logic from a secondary TOD 70 retrieved from Event Model 68, to a second provisional final shape. If no secondary TOD 70 is found in the Event Model 68 for the secondary event category and subtype, then an error message is sent to Hardware Processor 12. Secondary TOD 70 may comprise filter logic which will map a subset of values from first Final Shape 75 to secondary ESOD 65 to generate a customized, non-generic data shape, based on business user instructions.

Generate VS based on ESOD 426 comprises Validation Module 76 generating a Verification Shape 77 by parsing the one or more secondary ESOD 65 retrieved from the Event Model 68. If no secondary Verification Shape 77 is found in the Event Model 68 for the one or more secondary ESOD 65, then an error message is sent to Hardware Processor 12.

Validate Inputs 428 comprises the Validation Module 76 comparing the secondary Verification Shape 77 to the second provisional final shape using a validation function embedded within the Verification Shape 77. If the Validation Module 76 determines that the second provisional final shape is valid, then the second provisional final shape will become Final FS (2FS) 430. EAS 70 generates the 2FS 430. In some embodiments, the second Final Shape 75 received by Final FS (2FS) 430 can be provided to the Secondary Analytics Server A/B 90/92. If the Validation Module 76 determines that the second provisional final shape is not valid, then an error message will be sent which identifies the error within the secondary ESOD 65. In some examples, each subtype has its validation logic to ensure the integrity of the additional context data.

Valid? 432 comprises the EDVM 80 performing a version validation on the event models used to generate the first and/or second Final Shape 75. The EDVM 80 will assess the initial and secondary EMOD(s) 60, ESOD 65 and TOD 70 to determine if Event the event model elements share one or more hierarchical elements within the version identifier. If an error is identified by the EDVM 80, then an error message will be provided to the Model 68, User Model 88, AI/ML Module 85 and business user interface containing the event model involved and the associated Final Shape 75.

Send to Secondary Analytics 434 comprises the validated second Final Shape 75 being sent to the Secondary Analytics Server A/B 90/92. In some embodiments, Secondary Analytics Server A 90 will compromise a tag manage which may be proprietary to a third party. In some embodiments, Secondary Analytics Server B 92 may be an internal tool.

Receive Results 436 comprises the results from the secondary analysis being provided to a business user through a user interface. In some embodiments, the results from the Secondary Analytics Server A/B 90/92 can be used for marketing, advertising or user experience optimization. In some embodiments, the second Final Shape 75 will be provided to the ML/AI Module 85 for the purpose of updating the Event Model 68 and User Model 88. The data shape received by Receive Results 436 will comprise one or more non-generic shape structures based on an event model defined by business user instructions.

Evaluate 438 comprises compiling the results from the EAS 70 and Secondary Analytics Server A/B 90/92 and providing the compiled results for the purpose of improving the models and business user logic used to generate the event and transformation logic, and the user event and context data. In some embodiments, the Event Model 68 can modify the available EMOD(s) 60, ESOD 65 and TOD 70 during live operation of the EAS 70. In some embodiments, the BU Logic Console 8 can modify the available EMOD(s) 60, ESOD 65 and TOD 70 during live operation of the EAS 70.

Update Data/Models 440 receives the compiled results from the first and secondary analysis and provides the results to the ML/AI Module 85 which will update the User Model 88 and Event Model 68. The ML/AI Module 85 may receive as an input one or more of the first Final Shape 75, second Final Shape 75, ESOD 65 and TOD 70 associated with the user triggered event input, secondary ESOD 65 and TOD 70, first Verification Shape 77, second Verification Shape 77, event category hierarchy and subtype identified for the user triggered event input, secondary event category and subtype, error messages flagged by the Validation Module 76, user event data, user context metadata and EMOD(s) 60.

In some embodiments, ML/AI Module 85 will provide Model Input 464 with new EMOD(s) 60 to be generated by Create New/Update EMOD(s) 466 based on drift within user event data. In some embodiments, ML/AI Module 85 may provide User Model 88 with augmented user context metadata based on data generated by other users, or simulations of a specific user or types of users, with shared user characteristics.

Model Input 464 comprises EAS 70 receiving instructions for updating, modifying or providing one or more EMOD(s) 60, ESOD 65 and TOD 70 within the Event Model 68. In some embodiments, model Input 464 involves the EAS 70 receiving instructions from the BU Logic Console 8 for updating, modifying or providing one or more EMOD(s) 60, ESOD 65 and TOD 70 within the Event Model 68.

Create New/Update EMOD(s) 466 comprises the EAS 70 generating one or more EMOD(s) 60 and providing the EMOD(s) 60 to the Event Model 68. EMOD(s) 60 can be generated at Create EMOD(s) 802 either at UEA 70 initialization or during live operation of UEA 70. New EMOD(s) 60 can be generated to reflect drift in the input data or new BU requests necessitating modified or new event categories or subtypes.

Corresponding ESOD Update 468 comprises Event Model 68 receiving the output from Create New/Update EMOD(s) 466, and generating or modifying one or more ESOD 65 associated with one or more EMOD(s) 60. The Event Model 68 stores the one or more ESOD 65, such that they can be retrieved at step 410, that have been generated based on event data and/or instructions from the BU Logic Console 8. Every one or more ESOD 65 is identified by an associated event category hierarchy and subtype, which will allow the Event Model 68 to quickly retrieve the relevant one or more ESOD 65 once the Listener 72 provides a user triggered input event. In some embodiments, EAS 70 receives new instructions, on demand into Event Model 68, through the BU Logic Console 8, which will update the one or more registered ESOD 65 by either modifying the underlying EMOD(s) 60 within the event logic, modifying the structure of the ESOD 65, or generating entirely new ESOD 65 for a new event category hierarchy and subtype.

If Needed, TOD Update Based on ESOD 470 comprises the Event Model 68, updating the one or more TOD 70, and underlying transformation logic, associated with one or more ESOD 65 which has been updated at step 468. In some embodiments, TOD Update Based on ESOD 470 involves the Event Model 68 updating the one or more TOD 70 based on instructions from the BU Logic Console 8, vand underlying transformation logic, associated with one or more ESOD 65 which has been updated at step 468.

In various embodiments, the method in FIG. 4 may make use of artificial intelligence and/or machine learning processes. There can be different types of artificial intelligence and/or machine learning processes based on one or more of a combination of unsupervised, supervised, regression, classification, clustering, dimensionality reduction, ensemble methods, neural nets and deep learning, transfer learning, natural language processing, word embeddings, and reinforcement learning. Such machine learning may be performed using processes and evaluation tools such as K-Means Clustering, Hierarchical Clustering, Anomaly Detection, Principal Component Analysis, APriori Algorithm, Naïve Bayes Classifier, Decision Tree, Logistic Regression, Linear Regression, Regression Tree, K-Nearest Neighbour, AdaBoost, Markov Decision Processes, Linear Bellman Completeness, Policy Gradient, Asynchronous Advantage Actor-Critic (AC3), Trust Region Policy Optimization (TRPO), Proximal Policy Optimization (PPO), Deep Q Neural Network (DQN), C51, Distributional Reinforcement Learning with Quantile Regressions (QR-DQN), Hindsight Experience Replay (HER) and the like. In one embodiment, the machine learning is based on one or more of business user feedback, business user EMOD feedback, deletion, and/or refinement, validation failure, analytics server validation success in combination with one or more of secondary analytics server failure, secondary analytics server result evaluations and low value results.

Event Model 68 stores sets of EMOD, ESOD and TOD associated with a user triggered event. Within Event Model 68, one or more ESOD 65 and TOD 70 are associated with every event category and subtype which has been registered due to instructions provided by Receive BU Analysis Logic Input 462. In some embodiments, Event 68 receives augmented event data from the ML/AI Module 85 which is used to create new EMOD(s) 60 and/or modify one or more ESOD 65 and associated TOD 75.

User Model 88 provides augmented contextual data associated with a user. This may include context metadata such as a user ID token, session ID, hardware capacities, software capacities, regions, encoding types, lighting, camera resolution, timestamps, exercise class context, workout context, membership level, user role, system hardware and other context metadata associated with an event input. In some embodiments, the context metadata from User Model 88 identifies whether the user is a customer support person assisting another user. In some embodiments, User Model 88 can determine whether a user is engaging with the system during an in-person retail engagement, on behalf of another user, using a specific application, using a specific web portal, using a specific regional web portal, using a specific interaction kiosk or augmented reality environment, combinations, or the like.

In some embodiments, User Model 88 contains historical data associated with users and/or user navigation. In some embodiments, User Model 88 provides depersonalized data. In some embodiments, context metadata provided by User Model 88 may be generated based on an AI/ML module 85 rather than specific human user behaviour. In some embodiments, User Model 70 may be updated with information related to the event input associated with the user and/or engagement evaluations related to the user. In some embodiments context data related to user activity history, user preferences, user devices, user companion engagement response history, user companion history, user type, user preferences, user membership, user purchase history, user wellness history, and the like are associated with the user. In some embodiments, User Model 88 may include data generated by other users, or simulations of a specific user or types of users, with shared user characteristics.

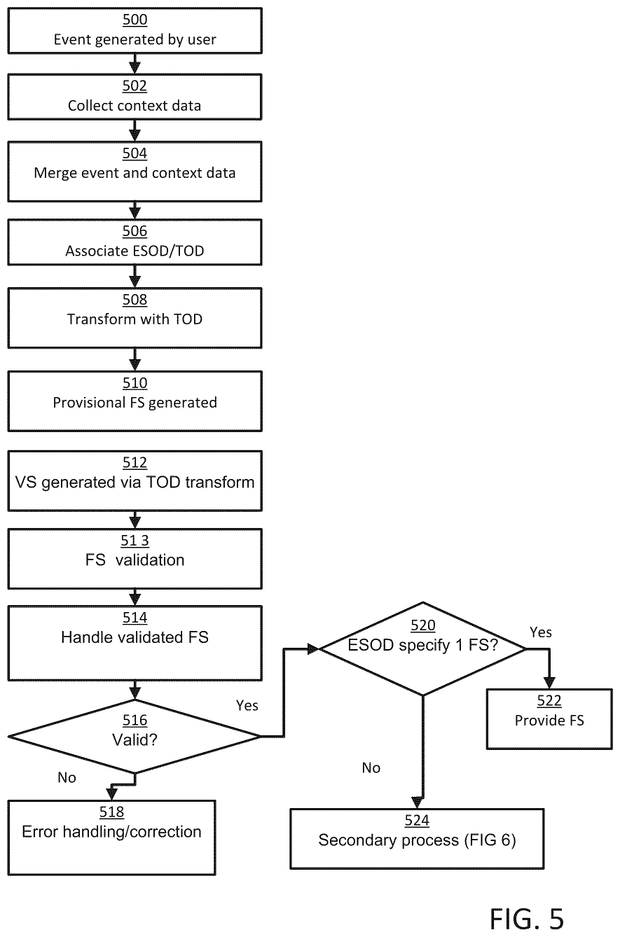

FIG. 5 shows an example method and architecture associated with receiving a user triggered event and generating/providing a final shape according to embodiments described herein.

Event Generated by User 500 occurs when a user interacts with an Input Device 15 within a User Interface 14 provided on User Device 10. An event is any evaluable user activity with a user interface associated with one or more specific identifier and type for which one or more value associated with a type may be assigned. Events may include standard and custom event types defined within EAS 70. The BU Logic Console 8 can transmit instructions to Listener 72, comprising tracking logic, for one or more controllers and/or sensors to track and preform measurements for standard or customized user events. Events may be a user input or behaviour characterizing a user product exploration, navigation, purchase, associated with a user interaction with a user interface. For example, an event may be any activity such as page load, page view, view content, link click, link hover, form completion, form partial completion, add to cart, add to wishlist, button click, checkout, page scroll, video view, application install, subscribe, login, purchase, search, ad click, button click, add payment info, complete registration, contact, customize product, donate, play audio, audio location, play video, video location, find location, logout, initiate chat conversation, end chat conversation, lead, initiate checkout, schedule, start trial, submit application, change setting, and combinations. Event Generated by User 500 can involve data capturing user interactions with an Input Device 15. This may include sensors data.

After Event Generated by User 500 occurs, Listener 72 will receive and store user event input data, associated with the Event Generated by User 500, from the one or more sensors and/or controllers. User event input data can comprise one or more of a user movement, interaction/engagement or location associated with gestures, or other navigational input, sensor data or electrical signals. The user event input data can be captured in real-time or near real-time.

Collect Context Data 502 occurs after Listener 72 has received and stored the user event input data associated with the Event Generated by User 500. Listener 72 will retrieve context metadate associated with the user event input from the client which registered the event. The context data collected will be comprised of a set of common data fields which are defined for all event types, a set of default context metadata which is defined by the default subtype, and a set of specific context metadata which is defined by the specific subtype, if one is identified. Context metadata may provide data such as user IP Address, user-agent string (browser and operating system) being used, timestamp of trigger event, duration associated with trigger event, referrer UR, device Type (for example a smartphone, tablet, or desktop computer), application or online version, operating system (Windows version, macOS version, Android version, and the like), browser type (for example Chrome, Firefox, Safari, or another browser), time of visit, user interactions (clicks, scrolls, form submissions, and combinations), and the like. In some embodiments, context metadata may be related to a user, device capacity, URL access or navigational context. For example, context metadata may include navigational context (user navigational path, search history, category/characteristics selection, a special offer, a promotion, general or demographically specific logic related to navigation, conversion history, purchase history, wishlist history, or the like, associated with all users, a subset of users, a group of users, a specific user or the intersecting values associated with such measures. In some embodiments, the context metadata may be received earlier in the process and already be contained within a user event input. In some embodiments, the navigational context includes such data as time of day, region, current temperature, current weather, associated with a specific user, device, GPS coordinate, or the like. Navigational context may also include generalized models and data related to user navigation. Generalized context models may be based on users within a region, demographic, access time frame, time stamp, purchase engagement criteria, membership level, the like, or combinations. In some embodiments, metadata related to the user may be retrieved from user model. In further embodiments, the context metadata is modified and/or improved based on ML or AI improvements to the Event Model 88 and User Model 68. In some embodiments, user metadata may include data generated by other users, or simulations of a specific user or types of users, with shared user characteristics. In some examples, ML/AI modules 85 receives this user metadata for processing user triggered event input and/or monitoring shape validations or updates.

Merge Event and Context Data 504 will combine the context metadata and user event input data to generate the user triggered event input which is provided by Listener 72 to the Shape Module 74 and Transformation Module 78.

Associate ESOD/TOD 506 retrieves, using the Event Model 68 and Listener 72, one or more ESOD 65 and associated TOD 70, based on event logic, which are associated with the event category hierarchy and subtype. After Listener 72 identifies the event category hierarchy, Listener 72 will then search for a subkey associated with a specific subtype within the user triggered event input. If Listener 72 identifies a subtype for the user triggered event input, then Event Model 68 will retrieve one or more ESOD 65 and associated TOD 70 which is associated with the subtype. If Listener 72 does not identify a subtype for the user triggered event input, then a default subtype will be used. If a default subtype is identified, then Event Model 68 will retrieve one or more default ESOD 65 and associated TOD 70 which are associated with the event category hierarchy. If a user triggered event input does not have a previously defined ESOD 65 and TOD 70 associated with the event category hierarchy and subtype identified by the Listener 72, then an error message will be sent to the business user. Associate ESOD/TOD 506 may involve using an association from analytics server. Event category/subcategory have an ESOD TOD association in analytics server, for example.

Transform with TOD 508 generates a final provisional shape, through the Transformation Module 78, using transformation logic to parse the one or more TOD 70 retrieved at step 506 and create a data structure which follows the shape of the associated ESOD 65. The transformational logic is stored within TOD 70, and maps the one or more EMOD(s) 60 in the event logic of the one or more ESOD 65 to the value from the user triggered event input. The result of the transformation done by Transform with TOD 508 is a data shape, defined by ESOD 65, with the default value or data element relationship of one or more EMOD(s) 60 replaced with the key or subkey from the user triggered event input containing the input data path.

Provisional FS Generated 510 comprises generating the first final provisional shape, as described in step 508, and providing the first provisional shape to the Validation Module 76. The generated data shape is provisional as it has not been validated against the Verification Shape 77 by the Validation Module 76. Provisional FS Generated 510 involves generating the provisional (not yet validated) shape associated with the event.

VS Generated via TOD Transform 512 generates a Verification Shape 77 by taking the one or more ESOD 65 associated with the event category hierarchy and subtype identified by Listener 72, and parsing the one or more ESOD 65 to create a provisional data shape. The Verification Shape 77 contains a validation function embedded within its structure, which in some embodiments can be a regular expression tool, which will establish valid inputs the data shape defined by the one or more ESOD 65 associated with the user triggered event input. VS Generated via TOD Transform 512 can involve generating validation data (e.g. event definition specific). FS Validation 513 occurs after the Validation Module 76 has received both the Verification Shape 77 and the first final provisional shape. The Validation Module 76 will run a shape validation to ensure that the final provisional shape can be parsed. The Validation Module 76 may use the regular expression validator, or some other form of validation logic, within the Verification Shape 77 to check that the values mapped from the user trigger event input, using TOD 70, to the associated ESOD 65 are a valid value. In some embodiments, Validation Module 76 may validate that the output data structure (i.e., string, Boolean, Array, etc.) of the first final provisional shape matches the data structure specified by the associated ESOD 65. Each registered event category and subtype combination will have a unique validation logic, housed within the Verification Shape 77, which ensures the integrity of the context metadata and event data mapped into the final provisional shape. In some embodiments, the Validation Module 76 may check that the EMOD(s) 60 used for the ESOD 65 and associated TOD 70, retrieved by Event Model 68, are available for the event category hierarchy and subtype identified.

Handle Validated FS 514 receives, from the Validation Module 76, the first final provisional shape and the results of the validation from step 513 for the one or more ESOD 65 and TOD 70 associated with the user triggered event input. If the Validation Module 76 provides a no-error signal, then the first final provisional shape will be tagged as Final Shape 75. If the Validation Module 76 provides an error signal, then the first final provisional shape will be tagged with an error message which will identify, within the first final provisional shape and user triggered event input, where the error occurred. Error Handling/Correction 518 consolidates the error messages for one or more first final provisional shapes and provides this consolidated information to the business user. Error Handling/Correction 518 can generate notification for invalid shapes in some embodiments. ML/AI module 85 can monitoring validation and error notifications in some embodiments. Input data can modify the event or transformation logic, or can modify the instructions within the BU Logic Console 8, to correct further errors from occurring. In some embodiments, error correction may include generating new EMOD(s) 60 to either modify or create new ESOD 65 and associated TOD 70. For example, this may occur if drift in the data has led to values within the user triggered event input having locations or value types which do not correspond to the current one or more EMOD(s) 60, ESOD 65 and TOD 70 associated with the event category hierarchy and subtype of the input. In some embodiments, the first final provisional shape, user triggered event input and identified error is provided to the ML/AI module 85, which will use the provided information to update the Event Model 68, specifically the transformation logic and event logic, and User Model 88.

ESOD Specify 1 FS? 520 receives, as an input from Handle Validated FS 514, a Final Shape 75 with an associated one or more ESOD 65. Within the one or more ESOD 65, there may be event logic which will determine whether secondary analysis is required. In some embodiments, ESOD 65 may have event logic which defines when to perform secondary analysis uses a Boolean operator, which will be set as true when a user triggered event input has a specified event or context data characteristic or element. For example, the event logic within ESOD 65 may require secondary analysis for a Final Shape 75 based on event or context data characteristic such as the event category hierarchy, subtype, platform associated with the event, application used by the user, the client, the location or any other combination of context and event input.

If ESOD Specify 1 FS? 520 determines that no secondary analysis is required for a user triggered event input, then Provide FS 522 will transmit the first Final Shape 75 to a business user interface and store the first Final Shape 75 within Database 30. The business user interface can be accessed by a business user, and data structures relevant to the business user can be extracted from the interface. In some embodiments, the Final Shape 75 will be provided to the ML/AI Module 85 for the purpose of updating the Event Model 68 and User Model 88. In some embodiments, Final Shape 75 will be provided to a tag manager.

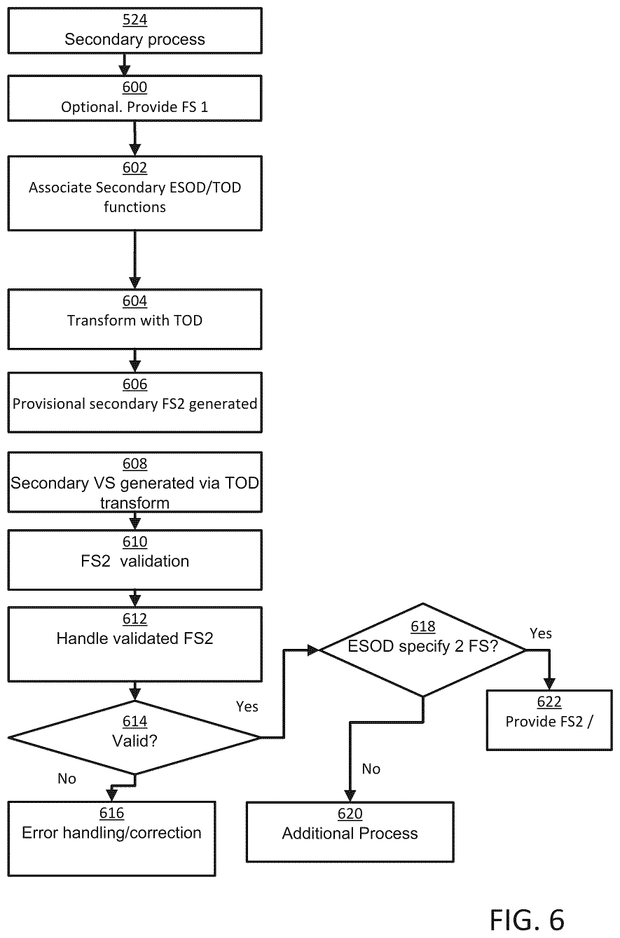

If ESOD Specify 1 FS? 520 determines that secondary processing is required for a user triggered event input, then Secondary Process 524 (as seen in FIG. 6) will receive the first Final Shape 75 from Database 30, through the Hardware Processor 12. Secondary processing (which may also be referred to as a secondary pass or analysis) is performed on a second Final Shape 75 generated through a secondary transformation logic being applied to first Final Shape 75. In some embodiments, the secondary processing is performed on EAS 70. In some embodiments, EAS 70 may also function as a tag manager. In a further embodiment, the secondary processing may be performed on another server of system 100, separate from the EAS 70 which generated the first Final Shape 75, which uses a different and/or proprietary format or protocol. In a further embodiment, the secondary processing may be performed on one or more devices, separate from or also involving EAS 70 which generated the first Final Shape, such as by the Hardware Processor 12. In a further embodiment, the secondary processing may be decentralized and implemented within one or more User Devices 10/11. Secondary Process 524 can involve data capturing user interactions with an Input Device 15. This may include sensors data. In some embodiments, the EAS 70 performs the secondary analysis using a different format or protocol. The Secondary Process 524 can be a second pass of the same ESOD and transformation process in FIG. 5, or a different ESOD and transformation process. In some embodiments, the process of FIG. 5 transform event data to the internal generic shape. The process of FIG. 6, when needed (i.e. non-internal event analysis for a specific event type) then takes the generic shape and transforms to another shape or protocol. This other shape or protocol may be for a secondary analytics server A 90 or secondary analytics server B 92, for example. The process of FIG. 6 can also transform the generic shape to specialized shape required by an internal component of server 20 or UEA 100, as well as third-party secondary analytics servers.

FIG. 6 shows an example method of further logic associated with refining a final shape according to embodiments described herein.

Secondary Process 524, as explained above, will perform further transformation and analysis on first Final Shape 75 to generate a second Final Shape 75 which provides a data shape (non-universal) and output customized to a protocol, format, standard, and/or specific business user instructions. Secondary Process 524 contains separate event logic and transformation logic then that can be stored within Server 20 for generating the first Final Shape 75. In some embodiments, the event and transformation logic for the second Final Shape 75 can be defined by user input data, through the BU Logic Console 8, and/or through the ML/AI Module 85.

Optional Provide FS 1 600 comprises the Hardware Processor 12 providing the first Final Shape 75 to the Transformation Module 78 and Shape Module 74. The first Final Shape 75 will be used as the input for a further transformation into a second, non-universal, Final Shape 75. This can be used for the Secondary Process 524. In some embodiments, the Final Shape 75 can be sent to the Secondary Analytics Server A/B 90/92 for further analysis.

Associate Secondary ESOD/TOD Function 602 comprises Listener 72 identifying the secondary ESOD 65 and TOD 70 associated with the second event subtype of the first Final Shape 75. The secondary subtype is not the same as the subtype used for associating the first ESOD 65 and TOD 70, as described at step 506. The secondary event subtype can be defined by input data requesting a customized, non-generic, data shape with a subset of the event data and context metadata contained in the first Final Shape 75. This may involve one or more separate ESOD and/or TOD or secondary ESOD 65 and TOD 70 nested in first. In some embodiments, the secondary event subtype is defined by the business user, through the BU Logic Console 8, which is requesting a customized, non-generic, data shape with a subset of the event data and context metadata contained in the first Final Shape 75. This may involve one or more separate ESOD and/or TOD or secondary ESOD 65 and TOD 70 nested in first. In some embodiments, the secondary subtype is defined based on a set of protocols associated with a secondary server.

In some embodiments, the instructions for secondary analysis can be generated by input data from one or more secondary server(s). In some embodiments, the instructions for secondary analysis can be generated by a business user within the BU Logic Console 8. EAS 70 will process these instructions into a second final shape comprising a third-party event logic. The third-party event logic is associated with an event category used to label the user triggered event input. When a user triggered event input is parsed into a Final Shape 75, the Listener 72 will identify that the event category of the user triggered event input has instructions for secondary analysis. The Listener will then validate that the first Final Shape 75, generated by parsing the user triggered event input, satisfies the third-party event logic which defines the conditions for performing secondary analysis.

The third-party event logic, stored within the ESOD 65 associated with the event category, will check if the Final Shape 75 output contains a characteristic which will trigger the secondary analysis. The trigger for secondary analysis can be defined by input data (such as business user data) and, for example, can be associated with one or more possible conditions: product conversion, length of view or interaction, amount (or number) of products interacted with, promotions available, new user, new page view, purchase price over/under an amount, and the like.

The third-party event logic can also contain further conditions in the form of third party job options. Third party job options may be received by UEA system 100. Third party job options may include specific instructions for different operations including: parsing and storing the second Final Shape 75, removing outputs or entire data structures which contain incompatible context metadata (i.e. platform, location or user profile that is incompatible with the secondary analysis or third party platform), delaying generation of the second Final Shape 75 until an entire user engagement or activity is completed (i.e. delaying generation of a second Final Shape 75 until a user has purchased a product or removed it from their cart), and allowing logging of results under a specific business user identity within Database 30. The EAS 70 may implement processing using the third party job options. These are examples and third-party job options may include different types of instructions for different operations.

If a first Final Shape 75 satisfies the conditions defined by the third-party event logic, then the Listener will label the first Final Shape 75, now treated as the input for the secondary analysis, with the secondary subtype associated with the third party event logic.

Shape Module 74 will retrieve a secondary ESOD 65 and TOD 70 from the Event Model 68 using the secondary subtype identified by Listener 72. The secondary ESOD 65 and associated TOD 70 comprises a separate set of event logic and transformation logic which defines a non-universal data shape which can be provided, as a second Final Shape 75, to a Secondary Analysis server A/B 90/92 for business user specific analysis. In some embodiments, the secondary ESOD 65 and associated TOD 70, and underling event logic and transformation logic, are defined by instructions received from the BU Logic Console 8. In some embodiments, the ML/AI Module 85 may update the secondary event model elements.

In some embodiments, the second ESOD 65 and associated TOD 70 are separate from the first ESOD 65 and associated TOD 70 such that the secondary analysis is a distinct step which uses the Final Shape 75 as the new user event input. In another embodiment, the secondary ESOD 65 and associated TOD 70 are nested within the first ESOD 65 and associated TOD 70 such that the secondary analysis will be performed during the initial transformation performed at Validation and Transformation 810.

Transform with TOD 604 comprises receiving the provided first Final Shape 75 and performing a secondary transformation using the secondary TOD 70, similar to the process explained in FIG. 5. The secondary transformation will use the transformation logic within the secondary TOD 70 to parse the secondary TOD 70 and generate a second provisional final shape having a data structure associated with the second ESOD 65 received from step 602. In some embodiments, more then one secondary TOD 70 and ESOD 65 are associated with the first Final Shape 75 at step 602, and consequentially there are multiple second provisional final shapes generated. The second provisional final shape is a data structure with a customized subset of values, value type and/or value ordering comprising a filtered subset of values from first Final Shape 75.

A benefit of the first Final Shape 75 having an internal universal shape is that the first Final Shape 75 can be transformed a second time using one or more TOD 70 which apply, based on the secondary event subtype, regardless of the server, platform, user or client which generated the user triggered event input. The universal shape achieved by the transformation to the Final Shape 75 makes the secondary analysis more efficient since the universal data shape will have matching locations for specific event data values which allows the secondary event and transformation logic defined by the business user to apply to all user events having the same category and subtype.

Provisional Secondary FS2 Generated 606 comprises the second provisional final shape, generated at Transform with TOD 604, being received by the Hardware Processor 12 and providing the second provisional final shape to the Validation Module 76. The generated data shape is provisional as it has not been validated against the Verification Shape 77 by the Validation Module 76. Provisional Secondary FS2 Generated 606 may involve generating the provisional (not yet validated) shape associated with the event.

Secondary VS Generated via TOD Transform 608 comprises taking the one or more secondary ESOD 65 associated with the secondary event category hierarchy and subtype identified by Listener 72, and parsing the one or more secondary ESOD 65 to generate a second Verification Shape 77. The second Verification Shape 77 contains a validation function embedded within its structure, which in some embodiments can be a regular expression tool, used to validate the output value, value type and structure for the data shape defined by the one or more secondary ESOD 65. Secondary VS Generated via TOD Transform 608 may involve generating Validation data (e.g., event definition specific).

FS2 Validation 610 comprises the Validation Module 76 receiving both the second Verification Shape 77 and the second final provisional shape and running a shape validation to ensure that the second final provisional shape can be parsed by the secondary analytics server. The Validation Module 76 may use the regular expression validator within the second Verification Shape 77 to check that the values mapped from the first Final Shape 75, using secondary TOD 70, to the associated secondary ESOD 65 are a valid value. In some embodiments, Validation Module 76 may validate that the output data structure (i.e., string, Boolean, Array, etc.) of the second final provisional shape matches the data structure specified by the associated secondary ESOD 65.

Handle Validated FS2 612, similar to the process from FIG. 5, comprises the Validation Module 76 receiving the second final provisional shape and the results of the validation from step 610. If the Validation Module 76 provides a no-error signal, then the second final provisional shape will be tagged as second Final Shape 75. If the Validation Module 76 provides an error signal, then the second final provisional shape will be tagged with an error message which will identify, within the second final provisional shape and first Final Shape 75 where the error occurred.

Error Handling/Correction 616 comprises consolidating the error messages for one or more second final provisional shapes and provides this consolidated information to the business user. Input data can modify the event or transformation logic, or can modify the instructions within the BU Logic Console 8, to correct further errors from occurring. In some embodiments, error correction may include modifying the filter logic within secondary ESOD 65 and secondary TOD 70. In some embodiments, the second final provisional shape and identified error are provided to the ML/AI module 85, which will use the provided information to update the Event Model 68, specifically the transformation, filter and event logic, and User Model 88. Error Handling/Correction 616 can generate notification for invalid shapes in some embodiments. ML/AI module 85 can monitoring validation and error notifications in some embodiments.

ESOD Specify 2 FS? 618 comprises receiving, as an output from Handle Validated FS2 614, a second Final Shape 75 with an associated one or more secondary ESOD 65. Within the one or more secondary ESOD 65, there will be event logic which will determine whether further analysis is required. In some embodiments, secondary ESOD 65 may have event logic for when to perform further analysis, operating using a Boolean operator, which will be set as true when first Final Shape 75 has a specified event or context data characteristic or element. For example, the event logic within secondary ESOD 65 may require further analysis for a second Final Shape 75 based on the event category, subtype, platform associated with the event, application used by the user, the client, the location, or any other combination of context and event data.

If ESOD Specify 2 FS? 618 determines that additional analysis is required for second Final Shape 75, then Additional Process 620 will receive the second Final Shape 75 from Database 30, through the Hardware Processor 12. Additional analysis may include further transformation of second Final Shape 75 or first Final Shape 75, or retrieving additional data values associated with a user or event. For example, an “add to bag click” event subtype may trigger additional processes to check for product availability, product stock, identify user preferences, or provide user or event data to ML/AI Module 85. In some embodiments, Additional Process 620 may be performed on the Secondary Analytics Server A/B 90/92. In another embodiment, Additional Process 620 may be performed on an internal Server 20, separate from the Secondary Analytics Server A/B 90/92, which may be centrally stored on the Hardware Processor 12. In another embodiment, Additional Process 620 may be decentralized and performed within User Device 10/11.

If ESOD Specify 2 FS? 618 determines that no additional analysis is required, then Provide 2FS 622 will transmit the second Final Shape 75 to a business user interface and store the second Final Shape 75 within Database 30. In some embodiments, Provide 2FS 622 may provide the second Final Shape 75 to a Secondary Analytics Server A/B 90/92. In some embodiments, the Secondary Analytics Server A 90 will compromise a tag manager. In a further embodiment, the Secondary Analytics Server A 90 may be proprietary to a third party. In another embodiment, the Secondary Analytics Server B 92 may be an internal tool which provides non-generic shape structures, defined by a business user, and the resulting analysis to a business user. In some embodiments, the Secondary Analytics Server A/B 90/92 is used for marketing, advertising or user experience optimization. In some embodiments, the second Final Shape 75 will be provided to the ML/AI Module 85 for the purpose of updating the Event Model 68 and User Model 88. Provide 2FS 622 can involve sending transformed enhanced input to Secondary Analytics Server A/B 90/92.

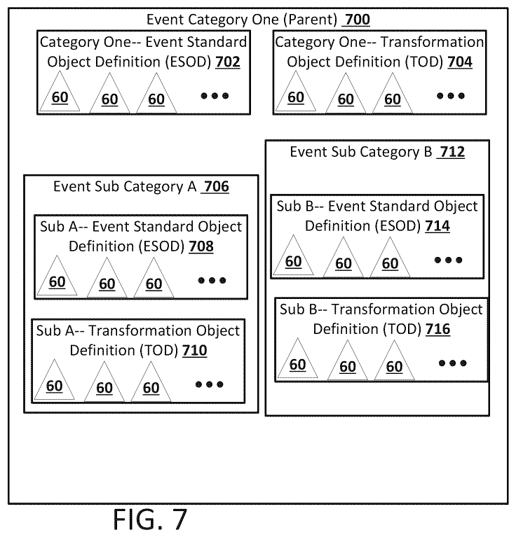

FIG. 7 shows an example user interface associated with and according to embodiments described herein.

Event Category One (Parent) 700 is associated with the user triggered event input based on a type of user behaviour or method of interaction which defines the user triggered event input. Event Category One 700 can be one of many categories within an event category hierarchy. For example, a hierarchy of categories can compose a first category of page view and a second category of component interaction. The Event Category One 700 is identified by Listener 72 and provided to the Event Model 68, through Shape Module 74. Listener 72 identifies an event category using the tracking logic which captured the event. The tracking logic can be provided to Listener 72 by the BU Logic Console 8, and instructs the Listener 72 to track events containing certain characteristics. When the tracking logic captures a user event, tracking logic identifier within Listener 72 (i.e., page view, component interaction) is passed onto the resulting user triggered input provided to Shape Module 74.

Event Subcategory A 706 and Event Sub Category B 712 represent event subtypes which define a specific characteristic of the user triggered event input, or a set of characteristics or elements. The tracking logic within Listener 72 will have one or more subtypes identified for each Event Category 700. Upon receiving a user triggered event input the Listener 72 will determine if a specific subtype has been identified by the tracking logic. If there is no specific subtype identified for a user triggered event input, then the default subtype within the tracking logic will be used. The event subtypes defined within the tracking logic are generated by EAS 70 using instructions from the ESOD definitions. In some embodiments the ESOD definitions may be defined using BU Logic Console 8. In some embodiments, tracking logic can be generated by the ML/AI Module 85. An event subtype is not required to adhere to a specific data shape based on the Event Category 700 it falls under. The event subtype can include, for example, product display page, button click on homepage, add to cart click, add to wishlist click, search string initiated, chat initiated, product customization click, recommended product click.

In some embodiments, the BU Logic Console 8 can provide a default ESOD 65 and associated TOD 70 for every Event Category 700, which will be generated when the default subtype is used. In some embodiments, the default ESOD 65 and associated TOD 70 is defined based on logic, created by the business user, within one or more EMOD(s).

For example, within Event Category One 700, there will be a default subtype which will be used if Listener 72 does not identify any specific subtypes within the user triggered event input. In the current embodiment, ESOD 708 and TOD 710, associated with Event Subcategory A 706, are generated as the default subtype, such that if the Listener 72 is unable to identify a subtype for an event input, then ESOD 708 and TOD 710 will be used.

Building on the example for Event Category One 700, if an event category associated with the user event is composed of a hierarchy of page view and component interaction. Then under the first event category of pageview, the specific subtypes, represented by Event SubCategory B 712 could be one or more of product display page, advertisements, new page views, recommended product page, and the like. For the second category of component interaction, the subtype could be one or more of button click on homepage, add to bag click, add to wishlist click, initiate chat, product customization selection, checkout completion click, recommended product click, search input, and the like.

The one or more ESOD 65 and associated TOD 70 stored within the Event Model 68 can be generated using event data. ESOD 65 and TOD 70 are structured to define an event category and subtype. For example, an event model having an Event category one 700 and an event subtype category B 712 would contain event logic from ESOD 702/712 and transformation logic from TOD 704/716. In some embodiments, the one or more ESOD 65 and associated TOD 70 stored within the Event Model 68 can be generated by the BU Logic Console 8 based on instructions from the BU. ESOD 65 and TOD 70 are structured to define an event category and subtype, for example, an event model having an Event category one 700 and an event subtype category B 712 would contain event logic from ESOD 702/712 and transformation logic from TOD 704/716.

Input data can adjust the available one or more ESOD 65 and associated TOD 70 within the Event Model 68 on demand. In some embodiments, the ML/AI Module 85 can generate one or more ESOD 65 and associated TOD 70 which will be provided to the Event Model 68. In some embodiments, new ESOD 65 and associated TOD 70 will be generated based on drift in the input data. In some embodiments, new ESOD 65 and associated TOD 70 will be generated, either by the BU Logic Console 8 or ML/AI Module 85, based on drift in the input data.

EMOD(s) 60 are identifiers which represent a relationship between a shape element and the input from the user triggered event input. EMOD(s) 60 are represented by an identifier which can be used by an ESOD 65 and TOD 70 to call the EMOD(s) 60 within the event and transformation logic. Each EMOD(s) 60 defines a different default value or data element relationship such that all user defined shape elements of the one or more Event Category 700 and Event Subcategory 706/712 are associated with an EMOD(s) 60 identifier within the EAS 70. In some embodiments, each EMOD(s) 60 defines a different default value or data element relationship such that all user defined shape elements of the one or more Event Category 700 and Event Subcategory 706/712 recognized by the BU Logic Console 8 are associated with an EMOD(s) 60 identifier within the EAS 70. EMOD(s) 60 can be structured as hierarchical, nested or recursive. One or more EMOD(s) 60 will be present within the event logic and transformation logic of ESOD 708/714 and TOD 710/716.

When a new event category or subtype is generated by the ML/AI Module 85, one or more new ESOD(s) 60 can be created to define the new shape elements introduced to the system. In some embodiments, when a new event category or subtype is generated by the BU logic Console 8 one or more new ESOD(s) 60 will be created to define the new shape elements introduced to the system.

In some embodiment, there may be no subtype ESOD as a default and there is an ESOD associated with the event category. In some embodiments, the ESOD shape logic is such that when a sub type ESOD for an event category is not defined an ESOD associated with the event category may be applied. In some embodiment, at least one subtype ESOD can be a default. Category One—ESOD 702, Sub A—ESOD 708 and Sub B—ESOD 714 represent the data shape that will define a potential Final Shape 75.

In an embodiment, Category One—ESOD 702 is the ESOD 65 for the event category, Sub A—ESOD 708 and Sub B—ESOD 714 are the ESOD 65 for the subtypes defined by EAS 70. The one or more EMOD(s) 60 which define the structure of the ESODs 702, 708 and 714 are associated with the input data retrieved by Listener 72 for the user triggered event input. Category One—ESOD 702, Sub A—ESOD 708 and Sub B—ESOD 714 represent the data shape that will define a potential Final Shape 75. In the current embodiment, Category One—ESOD 702 is the ESOD 65 for the event category, Sub A—ESOD 708 and Sub B—ESOD 714 are the ESOD 65 for the possible subtypes defined by the BU Logic Console 8, for some embodiments where at least one subtype will be a default.

The input data within a user triggered event input comprises a combination of event data and context metadate. The tracking logic which retrieves the input data will collect general data which is common across all event categories. These values are associated with EMOD(s) within ESOD 702, and can include time stamp, user session information, IP address and device type. The tracking logic will also retrieve generic context metadata which is defined by the default subtype of an event category. These values are associated with EMOD(s) 60 within ESOD 706. The tracking logic will retrieve specific context metadata if a specific event subtype is identified which is represented by EMOD(s) 60 within ESOD 714.

For example, Sub A—ESOD 708 could be structured to define a data shape for an array of products that were added to a cart, in which the EMOD(s) 60 associated with products ID, product name and price is called by the event logic within 708. Since the EMOD(s) 60 for product is defined to provide a string value type of product ID and product name, this will be structured into an array within the Final Shape.

Category One—TOD, 704 Sub A—TOD 71 and Sub B—TOD 716 contains transformational logic which maps one or more value(s) from the user triggered event input to the data shape defined by the ESOD 65. The transformational logic will replace the default value or data element relationship of one or more EMOD(s) 60 with the key or subkey from the user triggered event input containing the input data path. The transformation logic will parse the matched TOD 70 into a provisional final shape.

Accordingly FIG. 7 provides an example illustration of multiple event categories and sub categories. Each event category can be associated with a provided ESOD/TOD. The ESOD/TOD may be defined and/or modified based on input data, such as, for example, BU console logic. EMODs can be nested and recursive. Each EMOD(s) 60 can be associated with an identifier, and each EMOD(s) 60 can define a different default value and/or a data element relationship.

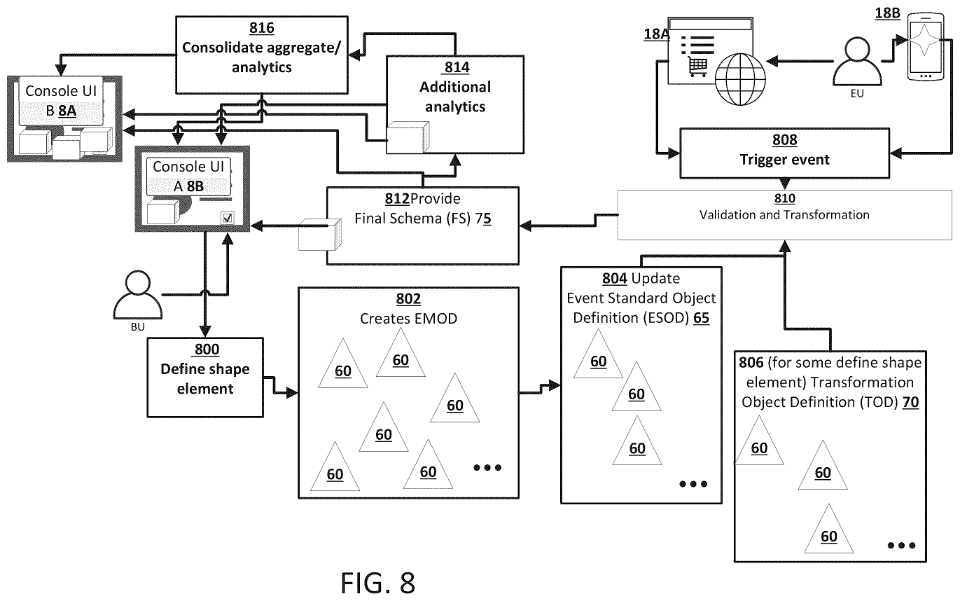

FIG. 8 shows an example workflow and method associated with a business user and end user associated with and according to embodiments described herein.

Console UI A 8B is an interface to receive input instructions into the BU Logic Console 8 to generate one or more user defined shape structures or elements. The user defined shape structure is associated with an event category hierarchy and subtype and will be represented in the Final Shape 75. The user defined shape structure will be composed of one or more user defined shape element(s). The one or more user defined shape structures are received by Define Shape Element 800. Define Shape Element 800 generates the one or more user defined shape elements which are associated with the user defined shape structure. A user defined shape element represents one or more value(s) which can be obtained from a tracked user event, such that it can be used to populate, or used in the logic for providing, the Final Shape 75. Console UI A 8B can provide an interface for defining shape element, and may also be used to provide shaped based event analytics and output.

As mentioned earlier, a user triggered input event is defined by an event category and subtype, in which the event category comprises data values from common data fields, and the subtype comprises additional data values from context metadata. A user defined shape element is associated with a data value within the event category or subtype such that a user defined shape element (e.g., received as input data) can be processed by EAS 70 into an event data or context metadata value within an event category or subtype.

Creates EMOD 802 generates one or more EMOD(s) 60 associated with the one or more user defined shape element. Each user defined shape element will have an EMOD(s) 60 which represents the default value or data element relationship of the user defined shape element. The one or more EMOD(s) 60 generated by Create EMOD 802 will be given an identifier which will be used within the event and transformational logic of the ESOD and TOD, respectively, to call the EMOD(s) 60. In some embodiments, two or more EMOD(s) 60 can interact through an EMOD logic such that an EMOD(s) 60 can have a hierarchal, recursive or nested structure. When one or more EMOD(s) 60 are generated, they represent an unstructured shape element, which can then be structured by event logic within an ESOD 65 to create a data shape. As noted, EMOD(s) 60 can be nested/recursive. In some embodiments, an EMOD 60 can be defined by relational EMOD logic. For example, input data can be used to create relational EMOD logic.

EMOD(s) 60 can be generated at Create EMOD(s) 802 either at UEA system initialization or during live operation of the UEA system. New EMOD(s) 60 can be generated to reflect drift in the input data or new requests necessitating modified or new event categories or subtypes.

When a business user wants to create or modify a data model, they can define a data shape element which will be processed by the EAS 70 system Logic Console 8 into one or more EMOD(s) 60, the EMOD(s) 60 will be associated with an event data value or context metadata value. The newly created EMOD(s) 60 can then be input into an existing event model, replace an existing EMOD(s) 60 in an event model or used to create a new event model. The ability for a business user to input instructions within a user interface, rather then having to modify coding language, provides greater adaptability to a business user.

In some embodiments, Update ESOD 804 receives the instructions from the BU Logic Console 8 to create or modify one or more ESOD 65 associated with one or more user defined shape elements. ESOD 65 defines a structure of EMOD(s) 60, in which EMOD(s) 60 are linked through event logic to form a data shape. The Event Model 68 stores the one or more ESOD 65 that have been generated based on the instructions from the BU Logic Console 8. Console UI A 8B receives new instructions live, which means that the one or more registered ESOD 65 can be modified on command by either modifying the underlying EMOD(s) 60 within the structure, modifying the structure of the ESOD 65, or generating entirely new ESOD 65 for a new event category hierarchy and subtype. Update ESOD 804 can define the structure of EMOD elements associated with an event.

Define Shape Element TOD 806 receives the event category and subtype of an associated user triggered event input, and retrieves an associated TOD 70. Every registered event category and subtype will be associated with a paired ESOD 65 and TOD 70. Define Shape Element TOD 806 can associate values and locations, for example.

User Device 18A/B captures a user triggered event within a user interface provided on User Device 18A/B. The user interface may be incorporated within a software application and/or website page. User Device 18A/B may be one or more of a smart phone, computer, tablet, smart exercise device, fitness tracker, smart mirror, connected fitness system, virtual reality device, virtual reality system, augmented reality device, augmented reality system, and the like. User Device 18A/B can include multiple user devices, or a single user device. User Device 18A/B may include multiple types of user devices that can be operated and interfaced with by a user. For example, in the current embodiment, User Device 18A is an online retail platform displayed through an internet browser, such as on a laptop, and User Device 18B is a retail platform displayed through an application on a smart phone.

In some embodiments, User Device 18A/B may be a smart exercise device, or a component within a connected smart exercise system. Types of smart exercise devices include smart mirror device, smart treadmill device, smart stationary bicycle device, smart home gym device, smart weight device, smart weightlifting device, smart bicycle device, smart exercise mat device, smart rower device, smart elliptical device, smart vertical climber, smart swim machine, smart boxing gym, smart boxing bag, smart boxing dummy, smart grappling dummy, smart dance studio, smart dance floor, smart dance barre, smart balance board, smart slide board, smart spin board, smart ski trainer, smart trampoline, or smart vibration platform.

Trigger Event 808 is a user event input which is detected by the Listener 72, through sensors and controllers which measure and receive inputs, characterizing a user product exploration, navigation, engagement, location or purchase associated with a user interaction with a user interface. For example, a user event input which will be registered as a Trigger Event 808 can be associated with gestures, navigational input, sensor data or electrical signals. The user event input data can be captured in real-time or near real-time. In some embodiments, upon identifying a Trigger Event 808, Listener 72 will retrieve context metadate associated with the user triggered event input subtype. In another embodiment, the user triggered event input already contains context metadata when it is received by Listener 72. Once the event data and context metadata are merged, the user triggered event input is provided by Listener 72 to the EAS 70. When Listener 72 identifies a Tigger Event 808, the Hardware Processor 12 will be notified through a messaging system. In response to a Trigger Event 808 being identified by Listener 72 and received by Hardware Processor 12, the Shape Model 68 will receive the event category hierarchy and subtype identified for the Trigger Event 808, and retrieve the ESOD 65 and associated TOD 70 from the Event Model 68.

Validation and Transformation 810 will receive the ESOD 65 and associated TOD 70 for the user triggered event input and produce a Verification Shape 77 and Final Provisional Shape. Verification Shape 77 is generated by parsing the ESOD 65 associated with the user triggered event input into a data structure containing a validation function. Final Provisional Shape is generated through the Transformation Module 78 using the transformation logic to parse the TOD 70 and create a data shape which follows the shape of the associated ESOD 65. The transformational logic stored within the TOD 70 maps the one or more EMOD(s) 60 in the ESOD 65 structure to the actual string value from the user triggered event input. Once the Verification Shape 77 and Final Provisional Shape are generated, the Validation Module 76 will run a shape validation to ensure that the Final Provisional Shape can be parsed. The Validation Module 76 will, at a minimum, use the validator function within the Verification Shape 77 to check that the values mapped from the user trigger event input, using TOD 70, to the associated ESOD 65 are a valid data type (i.e. string, Boolean, Array, etc.) and that the EMOD(s) 60 used for the ESOD 65 and associated TOD 70 are available for the event category hierarchy and subtype identified. The transformation process is discussed further in FIG. 7, and the validation process is discussed further in FIG. 5.

Provide FS 812 will transmit the Final Shape 75 to the Console UI A 8B and Console UI B 8A, which will allow the Final Shape 75 to be viewed on a user interface. In some embodiments, the Final Shape 75 will be provided to a secondary analytics process which will allow further transformations to be performed based on system requirements and requests.

Additional Analytics 814 is an optional function which will perform further analysis on the Final Shape 75, using the Final Shape 75 as the input, to refine the values within the Final Shape 75 for specific business units. The secondary analysis performed at Additional Analytics 814 can comprise a second ESOD 65 and associated TOD 70. In some embodiments, the secondary ESOD 65 and associated TOD 70 is separate from the first ESOD 65 and associated TOD 70 such that the secondary analysis is a distinct step which uses the Final Shape 75 as the new user event input. In another embodiment, the secondary ESOD 65 and associated TOD 70 are nested within the initial ESOD 65 and associated TOD 70 such that the secondary analysis will be performed during the initial transformation performed at Validation and Transformation 810. In some embodiments, the instructions to perform the secondary analysis can be imbedded in the first ESOD 65. The universal shape achieved by the transformation to the Final Shape 75 makes it efficient to perform secondary analysis for a large variety of user events as user events across different platforms, regions and devices will have matching locations for specific values. In some embodiments, the secondary analysis may comprise and/or function as a tag manager. In some embodiments, the secondary analysis is performed for marketing, advertising or user experience optimization. In some embodiments, further analysis can be performed after the secondary analysis has been completed including further transformation of second Final Shape 75 or first Final Shape 75, or retrieving additional data values associated with a user or event.

Consolidate Aggregate/Analytics 816 will receive the results of the secondary analysis performed at Additional Analytics 814 and consolidate them with other secondary analysis performed on an associated user triggered event input. The consolidated results can then be provided to the business user or to an additional analytics process. In some embodiments, the results of the secondary analysis will be provided to the ML/AI Module 85 for the purpose of updating the Event Model 68 and User Model 88.

Console UI B 8A is an interface that can receive the results of the Final Shape 75 and Additional Analytics 814. The Console UI B 8A can be accessed by a business user, and data structures relevant to the business user can be extracted from the interface. Console UI A 8B will also receive the results of Consolidate Aggregate/Analytics 816 and Final Shape 75, which will be used to train and update the ML/AI Module 85, Event Model 68 and User Model 88.

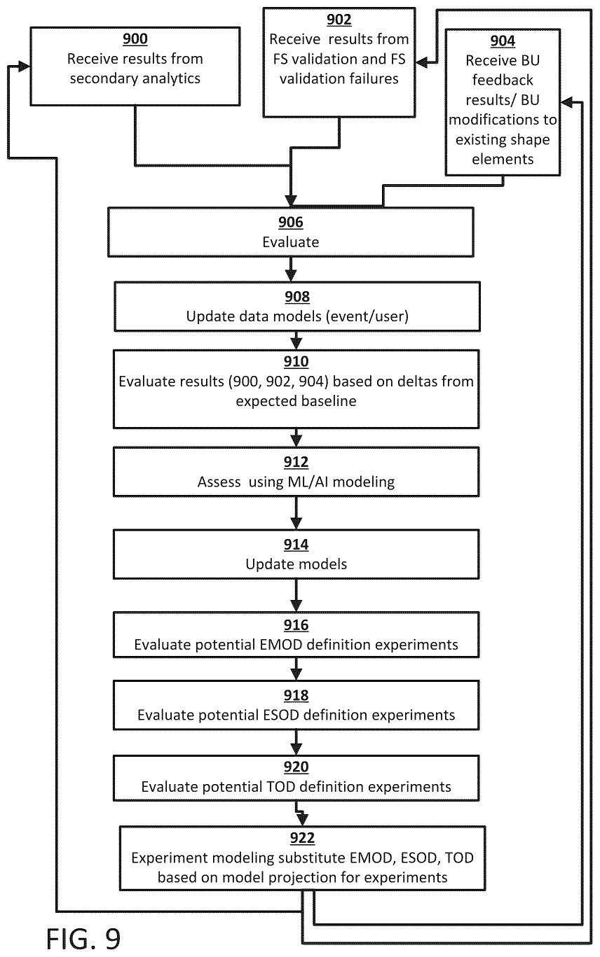

FIG. 9 shows an example method for training an AI/ML model and updating the event model using modeling to improve the accuracy and efficiency associated with generating a valid final shape which can be used for analysis by the business user.

Receive Results from Secondary Analytics 900 comprises receiving, using at least one hardware processor 12, a set of data defining one or more secondary ESOD 65 and associated TOD 70, first Final Shape 75 used as an input for secondary analysis, second Final Shape 75, event input, context metadata input, including user history, and results from user experience analysis such as A/B testing.

Receive Results from FS Validation and FS Validation Failures 902 comprises receiving, using at least one hardware processor 12, one or more second Final Shape 75, second provisional Final Shape, first Final Shape 75, first provisional final shape, error flags raised by Validation Module 76, location and type of error within the failed provisional final shape and event input, and associated user triggered event input including event data.

Receive BU Feedback Results/BU Modifications to Existing Shape Elements 904 comprises receiving, using at least one hardware processor 12, feedback from business users on the results from the EAS 70 and second analytics server A/B 90/92, and instructions input through the business user interface for new event values to be tracked, new event categories and/or subtypes, new EMOD(s) 60 created and, modifications to one or more ESOD 65 and associated TOD 70.

Evaluate 906 comprises the ML/AI Module 85 compiling the data inputs from steps 900, 902 and 904 and evaluating the data inputs to determine initial improvements to the Event Model 68 and User Model 88. In some embodiments, the updated event logic and transformation logic generated by the ML/AI Module 85 is used to improve the secondary analysis performed by third party.

Update Data Models (Event/User) 908 comprises the AI/ML Module 85 providing augmented event and context data to the Event Model 68 and User Model 88. In some embodiments, the augmented event model can provide the Event Model 68 with one or more new EMOD(s) 60, new/modified ESOD 65 and new/modified TOD 70. In some embodiments, the augmented event model will improve the event logic and transformation logic to reflect drift within the event data or user triggered event inputs which led to failed validations. In some embodiments, the augmented context metadata may be based on simulations of a specific user or types of users, with shared user characteristics. In some embodiments, the User Model 88 may be updated with context metadata associated with a user, type of user and/or engagement evaluations related to the user or type of user, such as user data related to user activity history, user preferences, user devices, user companion engagement response history, user companion history, user type, user preferences, user membership, user purchase history, user wellness history, and the like.

Evaluate Results (900, 902, 904) Based on Deltas from Expected Baseline 910 comprises the ML/AI Module using user triggered event inputs and context metadate stored within EAS 70 to compare the updated data models, comprising the augmented inputs from Update Data Models 908, against the baseline behaviour of the Event Model 68 and User Model 88. Baseline behaviour is collected by performing measurements for obtaining the input, such as sensor data or electrical signals, characterizing a user current baseline behaviour. In some embodiments, deltas considered by the ML/AI Module 85 can include the percentage of valid Final Shapes 75 provided, the variation of event data tracked, the potential for secondary analysis, and semantic analysis of event outcomes and system efficacy.

Assess Using ML/AI Modeling 912 comprises using the user triggered event input, including event and context data, received by the ML/AI Module 85 to track emerging patterns within the input data.

Update Models 914 comprises the ML/AI Model 85 updating the Event Model 68 and Event Model 88 to optimize the event analytics system. Event models can be updated in response to trends within the input data, such that one or more EMOD(s) 60, ESOD 65 and TOD 70 can be provided to the Event Model 68 to define new subtypes which respond to the data trends. In some embodiments, ML/AI Model 85 will update the processor executable instructions and processor-readable data stored within the models such that the updated data and instructions are optimized towards decreasing failed validation of provisional final shapes generated using the event models stored within Event Model 68.

Evaluate Potential EMOD Definition Experiments 916 comprises assessing one or more potential EMOD(S) 60 based on their performance using a subset of event and context metadata received by ML/AI Module 85.

Evaluate Potential ESOD Definition Experiments 918 comprises assessing one or more potential ESOD 65 based on their performance using a subset of event and context metadata received by ML/AI Module 85. Potential ESOD 65 contains a structure of one or more potential EMOD(s) 60 from step 916, which are ordered using event logic.

Evaluate Potential TOD Definition Experiments 920 comprises assessing one or more potential TOD 70 based on their performance using a subset of event and context metadata received by ML/AI Module 85. Potential TOD 70 contains transformation logic which will map event data values to the associated potential EMOD(S) 60 within potential ESOD 65.

The performance of the one or more potential EMOD(s) 60, ESOD 65 and TOD 70 is evaluated using the metrics discussed at step 910.

Experiment Modeling Substitute EMOD, ESOD, TOD Based on Model Projection for Experiments 922 comprises compiling the results from steps 916, 918 and 920, and selecting potential EMOD(s) 60, ESOD 65 and TOD 70 to be used within a model simulation. The model simulation will run the potential EMOD, ESOD and TOD within a simulated event analytics system using simulated user inputs comprising actual user data and actual context metadata, as well as ML/AI generated user data and context metadata associated with emerging data trends. The results from the model simulation will be provided as inputs for further AI/ML modeling. Potential EMOD(s) 60, ESOD 65 and TOD 70 which improve event model performance within the simulated event analytics system can be provided to a business user interface for confirmation, upon which the Potential EMOD(s) 60, ESOD 65 and TOD 70 will be updated live into the event model.

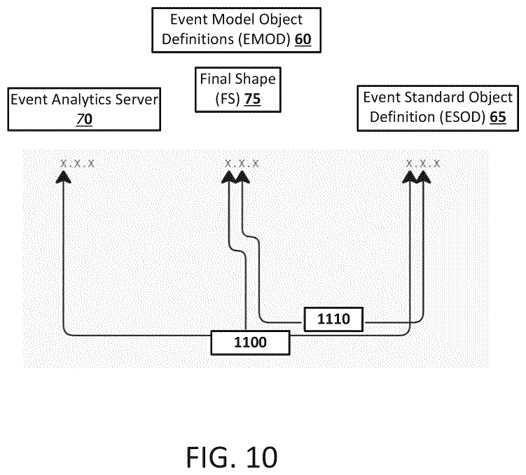

FIG. 10, shows a versioning logic example associated with and according to methods and embodiments described herein.

Due to the modular structure and relationships between EMODs and ESODs, the system 100 can modify or create new event model elements without impacting the other event models within EAS 70. For example, a business user can create a new EMOD(s) 60 and then the system can use the created EMOD(s) 60 to modify an ESOD 65 and TOD 70 for a specific event category and subtype, such that only the impacted EMOD(s) 60, ESOD 65 and TOD 70 will experience a version change.

Within FIG. 10, ESOD 65, EMOD 60 and Final Shape 75 are associated with the same preliminary version identifiers. The versioning validation is performed by the EDVM 80 when the EAS 70 is performing the transformation and validation. A hierarchical version identifier is used by EDVM 80 to track the version of an event model element. Within the hierarchical version identifier is a major version identifier, minor version identifier and patch version identifier, for example, the following is an example identifier “1.3.4 (Major.Minor.Patch). In some embodiments, the Major Version Identifier 1100 represents a system wide update, the Minor Version Identifier 1110 represents an update to a specific event model (i.e., ESOD and EMOD for an event category and subtype), and a patch version identifier represents an update to a specific element within an event model (i.e. EMOD(s) or ESOD). Version Identifier 1100 may implement granular object versioning which may be used to support the decentralized EAS 70/EMOD 60/ESOD 65 architectures structure. In some embodiments, versioning can be validated in conjunction with transformation and validation operations for shapes.

When the EAS 70 system is first initiated, all EMOD(s) 60 and ESOD 65 will have the same version identifier (i.e., 1.0.0). The system 100 can receive input data and/or programmatic updates. AI/ML Module 85 can input modified or new event model elements into the EAS 70, the version identifiers will diverge. The EDVM 80 will pass an event model as valid if the EMOD(s) 60 and ESOD 65 used to generate Final Shape 75 share one or more hierarchical elements within the version identifier.

For example, instructions to create a set of new EMOD(s) 60 which will be used to modify an ESOD 65 will lead to the following version identifier changes. The newly created EMOD(s) 60 will be given the current Major Version Identifier 1100 of EAS 70, the current Minor Version Identifier 1110 of the event model, and a patch version identifier of 1. The modified ESOD 65 will be given the current Major Version Identifier 1100 of EAS 70, the current Minor Version Identifier 1110 of the event model, and a patch version identifier of 2 (due to the new structure adding the new EMOD(s) 60). Any EMOD(s) 60 which previously formed part of the structure of the modified ESOD 65 will have the Major Version Identifier 1100 of EAS 70, the current Minor Version Identifier 1110 of the event model, and a retain a patch version identifier of 1.

Utilizing the relationships defined in the system 100 wherein an EMOD can define a relationship and/or value associated with another EMOD, and/or an EMOD can be used by more than one ESOD within the overall structure in, EAS 70 allows granular object versioning to be incorporated into EAS 70 through header and/or content type validation. In embodiments containing a decentralized event analytics system, the EAS will use granular versioning such that event models can be in different versions. The decentralized EAS will utilize unique event category and subtype headers for each version of an event model, allowing versioning validation to occur through identifying a unique event model header/content type which contains user requested version of EMOD(s), ESOD 65 and TOD 70. The relationship between the EMODs and ESODs can provide flexibility, versioning, customization, and so on. An ESOD can define a category and/or category subtype.

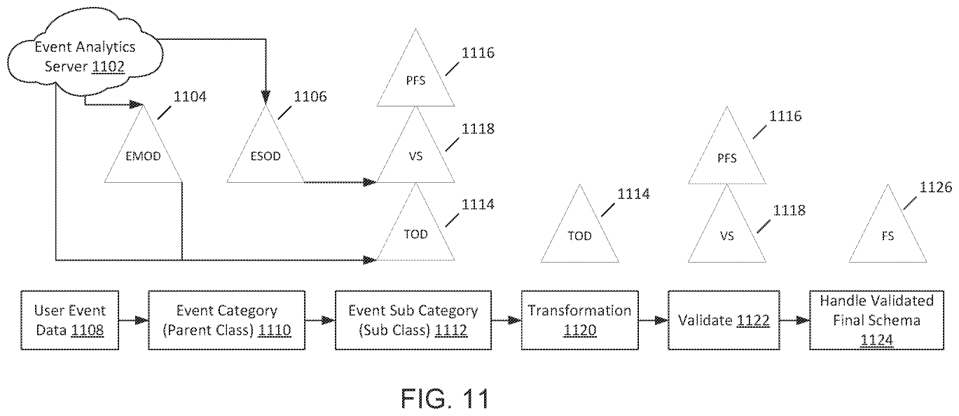

FIG. 11 shows an example architecture of the relationship between EMOD, ESOD, TOD, Verification Shape and Provisional Final Shape within the Event Model according to embodiments described herein.

Event Analytic Server 1102 stores event models and receives logic for creating EMOD(S) 60 and modifying ESOD 65 and associated TOD 70. When inputs instructions are provided to the BU Logic Console 8, the EAS 70 will receive a set of user defined shape elements which are processed by Shape Module 74 into one or more EMOD(s) 60. EMOD 1104 represents the connection between receiving one or more user defined shape elements and generating one or more EMOD(s) 60, which are then stored within Event Model 68. EMOD(s) 60 are provided to ESOD 1106 and TOD 1114 to structure the event logic and transformation logic used to generate the provisional final shape 1116. ESOD 1106 represents the generation of an ESOD 65 by Shape Module 74 using instructions from the BU Logic Console 8, through EAS 1102. ESOD 65 structures the EMOD(s) 60 generated at EMOD 1104 into a data shape defining an event category hierarchy and subtype. An event category and subtype, as defined within an ESOD 65, are composed of structured EMOD(s) 60 associated with event data and context metadata. TOD 1114 represents the generation of a TOD 70 by Transformation Module 78 using the same inputs as ESOD 1106. TOD 70 is composed of a transformation logic which is associated with the same event category and subtype of the paired ESOD 65. The transformation logic will map the EMOD(s) 60 within the structure of ESOD 65 to the user triggered event input. TOD 70 will generate a provisional final shape which will comprise the data shape defined by ESOD 65 and contain the data values, represented by EMOD(s) 60 within the ESOD 65, defined by the event category and subtype identified for the user triggered event input.

User Event Data 1108 comprises user device 10 receiving a user input event comprising a user engagement, interaction or navigation. The user event can be received through a user interface 14 within user device 10, which may be coupled to an input device 15 which allows a user to interact with the interface 14. Listener 72 will contain tracking logic, comprising instructions from BU Logic Console 8 to track user event inputs of interest to the user. The tracking logic is labeled with an event category, representing a high-level characteristic of the user event (i.e. component interaction, page view) and contains one or more subtypes which further define user events based on specific activity related to the user event (i.e. button clicks, product display page, conversions, search strings entered). When the tracking logic captures a user event, it is retrieved by the Listener and labelled, at Event Category (Parent Class) 1110 and Event Subcategory (Sub Class) 1112 with the event category and subtype associated with the tracking logic which captured the event. The resulting input is now considered a user triggered event input. Based on the event subtype within the tracking logic which captured the user triggered event, additional context metadata will be collected which is defined by the event subtype. There will also be a generic set of context data which is collected for all event categories. The context metadata retrieved by Listener 72 will be merged with the event data already within the user triggered event input.

Now that the user triggered event input is labelled with an event category and subtype, the Event Subcategory (Sub Class) 1112 will be used by Shape Model 74 to retrieve from Event Model 68 the ESOD 65 and TOD 70 associated with the event category and subtype of the user triggered event input.

Transformation 1120 comprises the Transformation Module 78 receiving the ESOD 65 and TOD 70 retrieved by the Shape Module 74. The Transformation Module will generate a provisional final shape 1116 by using the transformation logic within TOD 70 to parse ESOD 65 into a data shape containing the event data and context metadata values within the user triggered input. The Provisional Final Shape 1116 will be provided to the Validation Module 76, which occurs at Validate 1122, where it will be validated against Verification shape 77. The Validation Model, at Validate 1122, will run the Verification Shape 77 against the provisional final shape 1116 and validate that the integrity of the event data and context metadata from the user triggered event input has maintained its integrity. The Validation Model 1122 performs the validation using a validation function embedded within Verification Shape 77, such as a regular expression tool, which will check that the data structure and value type match the data shape defined by ESOD 65.

Handle Validated Final Schema 1124 will receive from Validate 1122 either an input containing a Validated Final Shape 1126 or an input containing a failed provisional final shape 1116. The input for a failed provisional final shape 1116 will identify the type of error and the location of the error within the provisional final shape and input data. When a validated final shape 1126 is received by Handle Validated Final Schema 1124, the final shape 75 will be provided based on user input or instructions. In some embodiments, the final shape 75 will be provided to a tag manager. In some embodiments, the final shape will be provided to a secondary analysis server where further transformations and analysis will occur. In some embodiments, the final shape 75 will be provided to the ML/AI Module 85 and used to update the Event Model 68 and User Model 88. In some embodiments, the final shape 75 will be provided to an interface contained on user device 11.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through one or more intermediate elements or devices via an electrical element, electrical signal or a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

The technical solution of embodiments may be in the form of a software product. The software product may be stored in a non-volatile or non-transitory storage medium. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A computer implemented method of operation in a system including an event analytics server associated with one or more listener module on at least one processor, the method comprising:
receiving, using at least one hardware processor a set of event logic comprising an event model defining more than one user triggered event;
wherein the event model comprises a set of elements associated with the more than one user triggered event, wherein the set of elements provide:
one or more event model object definition (EMOD) wherein the EMOD defines default values and/or a data element relationship within the system;
one or more event standard object definition (ESOD) wherein the ESOD, defines a data model, shape, and event logic comprising an event category hierarchy and type associated with one or more user triggered event;
one or more transformation objects definition (TOD) wherein the TOD, defines a model and transformation logic for determining a final shape using the ESOD and one or more EMOD;
wherein the ESOD comprises one or more EMOD;
wherein the TOD follows the shape of the ESOD and comprises one or more transformation paths, wherein the transformation path specifies a location associated with a value in the event standard object definition (ESOD) associated with a EMOD;
receiving, by the event analytics server on at least one processor, a user triggered event input wherein the user triggered event input is defined by the event category hierarchy and type, and one or more values associated with the event,
receiving, by the event analytics server, one or more context metadata value;
associating the one or more context metadata value with the user triggered event input to define an initial user triggered event input;
providing the initial user triggered event input to a listener module;
identifying, based on evaluating the event category hierarchy and type, the first associated ESOD and the first associated TOD for the user triggered event input;
transforming the values associated with the user triggered event input into a first provisional final shape (1PFS);
generating a validation shape (VS) using the associated ESOD to define a required shape structure and required value types;
validating the first provisional final shape (1PFS) against the VS;
upon validating the first provisional final shape, identifying the first provisional final shape as a first final shape (1FFS) and providing the first final shape.

2. The method of claim 1 further comprising receiving one or more user defined shape element, generating one or more EMOD associated with the one or more user defined shape element, and updating one or more ESOD associated with the one or more user defined shape element.

3. The method of claim 1 wherein the one or more event model object definition (EMOD) defines a nested, hierarchical, or recursive data element relationship within the system.

4. The method of claim 1 wherein providing comprises transmitting and/or outputting the first final shape to a user interface.

5. The method of claim 1 wherein providing comprises transmitting and/or outputting the first final shape to a secondary analytics server.

6. The method of claim 1 further comprising: determining that one or more secondary transformations is required for the user triggered event input, and generating a second final shape by applying transformation logic to the first final shape.

7. The method of claim 6 wherein providing comprises outputting the second final shape to a secondary analytics server.

8. The method of claim 1 further comprising versioning validation wherein a hierarchical version identifier associated with the event analytics server, the ESOD and the one or more EMOD associated with the ESOD share one or more hierarchical elements within the version identifier.

9. The method of claim 1 further comprising transmitting the final shape to a tag manager component.

10. The method of claim 1 further comprising receiving a plurality of user triggered events and providing a plurality of first final shapes, wherein the plurality of user triggered events are triggered simultaneously.

11. The method of claim 1 further comprising receiving another user triggered event input, wherein the other user triggered event input is associated with user engagement, and associating one or more context metadata values with the other user triggered event input to define another initial user triggered event input.

12. The method of claim 1 further comprising associating the initial user triggered event input with a secondary analytics server type and secondary set of event logic comprising another event model.

13. The method of claim 12 further comprising transforming the initial user triggered event input to match a set of protocols for the secondary analytics server, and sending the transformed initial user triggered event input to the secondary analytics server.

14. The method of claim 1 further comprising using a machine learning module for one or more operations selected from the group of providing additional context metadata for the user triggered event input, monitoring validating of the first provisional final shape, determining common shape types, recommending changes to one or more EMOD, recommending changes to one or more ESOD, determining one or more errors requiring changes to one or more EMOD, determining one or more errors requiring changes to one or more ESOD, generating a new EMOD, and generating a new ESOD.

15. A processing system that includes one or more processors and one or more memories coupled with the one or more processors, the processing system for event handling and analytics, the system comprising:
an event analytics server associated with one or more listener module; and
one or more non-transitory memory storing a set of event logic comprising an event model defining more than one user triggered event;
wherein the event model comprises a set of elements associated with the more than one user triggered event, wherein the set of elements provide:
one or more event model object definition (EMOD) wherein the EMOD defines default values and/or a data element relationship within the system;
one or more event standard object definition (ESOD) wherein the ESOD, defines a data model, shape, and event logic comprising an event category hierarchy and type associated with one or more user triggered event;
one or more transformation objects definition (TOD) wherein the TOD, defines a model and transformation logic for determining a final shape using the ESOD and one or more EMOD;
wherein the ESOD comprises one or more EMOD;
wherein the TOD follows the shape of the ESOD and comprises one or more transformation paths, wherein the transformation path specifies a location associated with a value in the event standard object definition (ESOD) associated with a EMOD;
wherein the event analytics server comprises at least one processor to:
receive a user triggered event input wherein the user triggered event input is defined by the event category hierarchy and type, and one or more values associated with the event;
receive one or more context metadata value;
associate the one or more context metadata value with the user triggered event input to define an initial user triggered event input;
provide the initial user triggered event input to a listener module;
identify, based on evaluating the event category hierarchy and type, the first associated ESOD and the first associated TOD for the user triggered event input;
transform the values associated with the user triggered event input into a first provisional final shape (1PFS);
generate a validation shape (VS) using the associated ESOD to define a required shape structure and required value types;
validate the first provisional final shape (1PFS) against the VS;
upon validating the first provisional final shape, identify the first provisional final shape as a first final shape (1FFS) and provide the first final shape.

16. The system of claim 15 further comprising a user device comprising a hardware processor and an interface to provide the user triggered event input, and one or more sensor to perform measurements for capturing one or more user gestures, wherein the user triggered event input is associated with the one or more user gestures.

17. The system of claim 15 wherein the event analytics server receives one or more user defined shape element, generates one or more EMOD associated with the one or more user defined shape element, and updates one or more ESOD associated with the one or more user defined shape element, wherein the one or more event model object definition (EMOD) defines a nested, hierarchical, or recursive data element relationship within the system.

18. The system of claim 15 wherein the event analytics server determines that one or more secondary transformations is required for the user triggered event input, and generates a second final shape by applying transformation logic to the first final shape, wherein the event analytics server associates the initial user triggered event input with the secondary analytics server type and secondary set of event logic comprising another event model, and transforms the initial user triggered event input to match a set of protocols for the secondary analytics server, and sends the transformed initial user triggered event input to the secondary analytics server.

19. The system of claim 15 further comprising an Event Definition Version Matcher Module for versioning validation using a hierarchical version identifier associated with the event analytics server, the ESOD and the one or more EMOD associated with the ESOD share one or more hierarchical elements within the version identifier.

20. The system of claim 15 wherein the event analytics server receives a plurality of user triggered events and provides a plurality of first final shapes, wherein the plurality of user triggered events are triggered simultaneously, wherein the plurality of user triggered events comprises user triggered event input associated with user engagement, and wherein the event analytics server associates one or more context metadata values with the other user triggered event input to define another initial user triggered event input.

21. The system of claim 15 further comprising a machine learning module for generating machine logic to implement one or more operations selected from the group of providing additional context metadata for the user triggered event input, monitoring validating of the first provisional final shape, determining common shape types, recommending changes to one or more EMOD, recommending changes to one or more ESOD, determining one or more errors requiring changes to one or more EMOD, determining one or more errors requiring changes to one or more ESOD, generating a new EMOD, and generating a new ESOD.

22. Non-transitory computer readable medium having stored thereon machine interpretable instructions executable by a processor to cause the processor to:
receive a set of event logic comprising an event model defining more than one user triggered event;
wherein the event model comprises a set of elements associated with the more than one user triggered event, wherein the set of elements provide:
one or more event model object definition (EMOD) wherein the EMOD defines default values and/or a data element relationship within the system;
one or more event standard object definition (ESOD) wherein the ESOD, defines a data model, shape, and event logic comprising an event category hierarchy and type associated with one or more user triggered event;
one or more transformation objects definition (TOD) wherein the TOD, defines a model and transformation logic for determining a final shape using the ESOD and one or more EMOD;
wherein the ESOD comprises one or more EMOD;
wherein the TOD follows the shape of the ESOD and comprises one or more transformation paths, wherein the transformation path specifies a location associated with a value in the event standard object definition (ESOD) associated with a EMOD;
receive a user triggered event input wherein the user triggered event input is defined by the event category hierarchy and type, and one or more values associated with the event,
receive one or more context metadata value;
associate the one or more context metadata value with the user triggered event input to define an initial user triggered event input;
provide the initial user triggered event input to a listener module;
identify, based on evaluating the event category hierarchy and type, the first associated ESOD and the first associated TOD for the user triggered event input;
transform the values associated with the user triggered event input into a first provisional final shape (1PFS);
generate a validation shape (VS) using the associated ESOD to define a required shape structure and required value types;
validate the first provisional final shape (1PFS) against the VS; and
upon validating the first provisional final shape, identify the first provisional final shape as a first final shape (1FFS) and provide the first final shape.
